(19) United States
(12) Patent Application Publication
(10) Pub. No.: US 2020/0225540 A1
(43) Pub. Date: Jul. 16, 2020

(54) LIQUID CRYSTAL DISPLAY PANEL, METHOD FOR MANUFACTURING LIQUID CRYSTAL DISPLAY PANEL, AND PHOTO-ALIGNMENT PROCESSING DEVICE

(71) Applicant: Sharp Kabushiki Kaisha, Sakai City, Osaka (JP)

(72) Inventors: Fumikazu SHIMOSHIKIRYOH, Sakai City (JP); Shinichi TERASHITA, Sakai City (JP); Kouichi WATANABE, Sakai City (JP)

(21) Appl. No.: 16/635,743

(22) PCT Filed: Jul. 27, 2018
(86) PCT No.: PCT/JP2018/028166

§ 371 Date: Jan. 31, 2020

(30) Foreign Application Priority Data
Aug. 3, 2017 (JP) 2017-151018

(51) Int. Cl. G02F 1/1337

(52) U.S. Cl. CPC G02F 1/133707; G02F 2001/133757; G02F 1/133753; G02F 1/133711

(57) ABSTRACT

The disclosure provides a liquid crystal display panel having excellent light utilization efficiency and display uniformity. The disclosure is a liquid crystal display panel including, in the following order, a first substrate including a first photo-alignment film, a liquid crystal layer, and a second substrate including a second photo-alignment film. Given an alignment vector in which a major axis edge of the liquid crystal molecules closer to the first substrate is set to a start point and a major axis edge of the liquid crystal molecules closer to the second substrate is set to an end point, the first and second photo-alignment films are subjected to an alignment process such that first to fourth domains are formed in a display unit region overlapping with one of the plurality of pixel electrodes in a longitudinal direction of the display unit region. In a plan view, the alignment vectors of the first and second domains are mutually perpendicular with the end points facing each other, the alignment vectors of the second and third domains are mutually parallel with the start points facing each other, and the alignment vectors of the third and fourth domains are mutually perpendicular with the end points facing each other.

### TECHNICAL FIELD

The present invention relates to a liquid crystal display panel, a method for manufacturing a liquid crystal display panel, and a photo-alignment processing device. More specifically, the present invention relates to a liquid crystal display panel having a configuration in which one pixel is divided into a plurality of alignment regions (domains), a method for manufacturing a liquid crystal display panel suitable for manufacturing the liquid crystal display panel, and a photo-alignment processing device.

### BACKGROUND ART

A liquid crystal display device is a display device in which a liquid crystal composition is used to perform display. In a typical display system for the liquid crystal display device, a liquid crystal display panel including the liquid crystal composition enclosed between a pair of substrates is irradiated with light from a backlight, and voltage is applied to the liquid crystal composition to change an alignment of liquid crystal molecules, thereby controlling an amount of light passing through the liquid crystal display panel. Such a liquid crystal display device has features such as a thin profile, light weight, and low power consumption, and is therefore utilized in electronic devices such as a smartphone, a tablet PC, and an automotive navigation system.

Conventionally, alignment division techniques have been studied in which one pixel is divided into a plurality of alignment regions (domains) and the liquid crystal molecules are aligned in different azimuthal directions in different alignment regions, thereby enhancing a viewing angle characteristic. Examples of prior art documents that disclose an alignment division technique include, for example, PTLs 1 to 3.

PTL 1 discloses a liquid crystal display device that includes a first substrate, a second substrate, a liquid crystal layer vertically aligned and provided between the first substrate and the second substrate, a voltage application means for applying voltage to the liquid crystal layer, and a plurality of pixels, each including the liquid crystal layer in which an alignment state changes in response to voltage applied by the voltage application means. The liquid crystal layer in each of the plurality of pixels includes a four-divided domain obtained by arranging, in this order in a certain direction, a first domain, a second domain, a third domain, and a fourth domain, in which respective alignment directions of liquid crystal molecules positioned near a center in a thickness direction of the liquid crystal layer differ from each other at least in a voltage applied state. Corresponding to the four-divided domain, the first substrate includes two first regions having a regulation force that aligns liquid crystal molecules of the liquid crystal layer in a first direction, and a second region having a regulation force that aligns the liquid crystal molecules in a second direction opposite to the first direction and provided between the two first regions, and the second substrate includes a third region having a regulation force that aligns the liquid crystal molecules in a third direction intersecting with the first direction, and a fourth region having a regulation force that aligns the liquid crystal molecules in a fourth direction opposite to the third direction. Boundaries between the respective domains are each extended in a direction orthogonal to alignment directions of the respective domains.

PTL 2 discloses a liquid crystal display device that includes a display substrate provided with a plurality of pixel areas and having a curved shape curved in a first direction, a counter substrate facing the display substrate, coupled to the display substrate, and having a shape curved along the display substrate, and a liquid crystal layer disposed between the display substrate and the counter substrate. A plurality of domains are defined in each of the plurality of pixel areas, directions in which liquid crystal molecules of the liquid crystal layer are aligned differ from each other in at least two of the plurality of domains, and the plurality of domains are arranged in a second direction intersecting with the first direction.

PTL 3 discloses a liquid crystal display panel including, in order, a first substrate provided with pixel electrodes, a liquid crystal layer containing liquid crystal molecules, and a second substrate provided with counter electrodes. The liquid crystal display panel further includes pixels provided with at least four alignment regions, namely, a first alignment region, a second alignment region, a third alignment region, and a fourth alignment region. In the four alignment regions, tilt azimuthal directions of the liquid crystal molecules differ from each other. The alignment regions are disposed in a longitudinal direction of the pixels in the order of the first alignment region, the second alignment region, the third alignment region, and the fourth alignment region. The tilt azimuthal directions of the liquid crystal molecules in the first alignment region and the second alignment region differ by substantially 180°, or the tilt azimuthal directions of the liquid crystal molecules in the third alignment region and the fourth alignment region differ by substantially 180°.

### CITATION LIST

### Patent Literature

PTL 1: JP 2006-85204 A

PTL 2: JP 2015-31961 A

PTL 3: WO 2017/047532

### SUMMARY OF INVENTION

### Technical Problem

It is known that, in the alignment division technique, discontinuities in the alignment of liquid crystal molecules occur at boundaries between domains in which the alignment directions of the liquid crystal molecules differ, resulting in the occurrence of dark lines. The dark lines occur because the region where the alignment of the liquid crystal molecules is discontinuous does not transmit light when the liquid crystal display is performed. When a dark line occurs, a transmittance (contrast ratio) of the pixels decreases, and a light utilization efficiency of the liquid crystal display panel decreases. In recent years, while the definition of pixels has become increasingly enhanced and an area per pixel has decreased, a ratio of an area covered by the dark lines in the pixel has increased due to the unchanging area of the dark lines even when the pixels are made smaller, making it more important to prevent a reduction in light utilization efficiency. Further, when the dark lines occur in different positions on a pixel-by-pixel basis, a uniformity of the display also deteriorates.

Furthermore, the enhancement of the definition of pixels has led to a need for a higher precision alignment process to divide one pixel into a plurality of domains. As a result, photo-alignment process is now used as an alignment processing method and, to achieve high productivity, studies have been conducted on the use of scanning exposure in the photo-alignment process.

In this regard, the inventions described in PTLs 1 to 3 leave room for further investigation into suppressing the occurrence of dark lines to improve light utilization efficiency and controlling the occurring positions of dark lines to improve display uniformity while supporting pixel definition enhancement.

FIG. 38 is a schematic plan view illustrating an example of a TFT substrate included in the liquid crystal display panel described in PTL 3, and FIG. 39 is a schematic plan view illustrating an example of the tilt azimuthal directions of the liquid crystal molecules in the liquid crystal layer in the liquid crystal display panel described in PTL 3. As illustrated in FIGS. 38 and 39, a liquid crystal display panel 400 described in PTL 3 includes two pixel electrodes 31 in one pixel, and thus a gate signal line G can be disposed crossing a center of the pixel and used for blocking the dark lines. Further, capacitance wiring lines CS1, CS2 are also disposed crossing the pixel, and can be used for blocking the dark lines. Nevertheless, to improve the transmittance of the pixel, there is a need for suppressing the occurrence of dark lines to improve the light utilization efficiency in a case that a wiring line crossing the pixel is not provided.

In light of the foregoing, an object of the present invention is to provide a liquid crystal display panel having excellent light utilization efficiency and display uniformity, a method for manufacturing a liquid crystal display panel suitable for manufacturing the liquid crystal display panel, and a photo-alignment processing device.

### Solution to Problem

The present inventors conducted various studies on methods for suppressing dark lines in a liquid crystal display panel in which one pixel is divided into a plurality of alignment regions (domains), and noticed that the state of occurrence of dark lines varies depending on the arrangement of the domains. Then, the inventors of the present invention identified a specific arrangement optimal for suppressing the dark lines, have conceived that this arrangement brilliantly solves the above-described problems, and have arrived at the present invention.

That is, an aspect of the present invention is a liquid crystal display panel including, in the following order, a first substrate including a plurality of pixel electrodes and a first photo-alignment film, a liquid crystal layer containing liquid crystal molecules, and a second substrate including a common electrode and a second photo-alignment film. Given an alignment vector in which a major axis edge of the liquid crystal molecules closer to the first substrate is set to a start point and a major axis edge of the liquid crystal molecules closer to the second substrate is set to an end point, the first photo-alignment film and the second photo-alignment film are subjected to an alignment process such that a plurality of domains are formed in a display unit region overlapping with one of the plurality of pixel electrodes, with the alignment vectors of the plurality of domains differing from one another. The plurality of domains include a first domain, a second domain, a third domain, and a fourth domain disposed in order in a longitudinal direction of the display unit region. In a plan view of the plurality of domains, the alignment vector of the first domain and the alignment vector of the second domain have a mutually orthogonal relationship with the end points facing each other, the alignment vector of the second domain and the alignment vector of the third domain have a mutually parallel relationship with the start points facing each other, and the alignment vector of the third domain and the alignment vector of the fourth domain have a mutually orthogonal relationship with the end points facing each other.

According to another aspect of the present invention, a method for manufacturing the liquid crystal display panel includes carrying out the alignment process on the first photo-alignment film and the second photo-alignment film, the alignment process including emitting polarized light from a light source through a polarizer from an oblique direction, rotating a polarization axis of the polarizer within a range from −15° to +15° from a 45° azimuthal direction, and adjusting an exposure direction on surfaces of the first photo-alignment film and the second photo-alignment film to a substantially 45° azimuthal direction relative to an irradiation direction of light.

According to yet another aspect of the present invention, a photo-alignment processing device used in the method for manufacturing a liquid crystal display panel includes at least one photo-irradiation mechanism including a light source, a polarizer, and a rotation adjustment mechanism, and configured to emit light from the light source to a liquid crystal display panel substrate through the polarizer, and a stage on which the liquid crystal display panel substrate is mounted. Light is emitted while the liquid crystal display panel substrate is moved or while the light source is moved relative to the liquid crystal display panel substrate, an irradiation direction of the light relative to the liquid crystal display panel substrate and a movement direction of the liquid crystal display panel substrate or a movement direction of the light source are parallel, and the rotation adjustment mechanism is configured to rotate the polarization axis of the polarizer and adjust the exposure direction on a substrate plane of the liquid crystal display panel to a substantially 45° azimuthal direction relative to the irradiation direction of the light.

### Advantageous Effects of Invention

According to the present invention, it is possible to provide a liquid crystal display panel having excellent light utilization efficiency and display uniformity, a method for manufacturing a liquid crystal display panel suitable for manufacturing the liquid crystal display panel, and a photo-alignment processing device.

### BRIEF DESCRIPTION OF DRAWINGS

FIG. 1 is a cross-sectional view schematically illustrating an example of a liquid crystal display device of an embodiment.

FIG. 2 is a plan view schematically illustrating tilt azimuthal directions of liquid crystal molecules in a liquid crystal layer of the embodiment.

FIG. 3 is a diagram for explaining a relationship between a tilt azimuthal direction of a liquid crystal molecule and an alignment vector.

FIG. 4 is a diagram illustrating examples of pixels in which a first domain, a second domain, a third domain, and a fourth domain satisfy a suitable relationship of alignment vectors.

FIG. 5 is a plan view schematically illustrating an electrode and wiring line structure of a first substrate according to the embodiment.

FIG. 6(a) is a plan view schematically illustrating tilt azimuthal directions of liquid crystal molecules corresponding to alignment vectors of two domains adjacent to each other, FIG. 6(b) is an enlarged view illustrating the tilt azimuthal directions of liquid crystal molecules in the two domains illustrated in FIG. 6(a) in further detail, and FIG. 6(c) is a diagram illustrating the tilt azimuthal directions of liquid crystal molecules present along arrows A and B in FIG. 6(a), when an angular difference between the alignment vectors of the domains adjacent to each other is 180°.

FIG. 7(a) is a plan view schematically illustrating tilt azimuthal directions of liquid crystal molecules corresponding to alignment vectors of two domains adjacent to each other, FIG. 7(b) is an enlarged view illustrating the tilt azimuthal directions of liquid crystal molecules in the two domains illustrated in FIG. 7(a) in further detail, and FIG. 7(c) is a diagram illustrating the tilt azimuthal directions of liquid crystal molecules present along arrows A and B in FIG. 7(a), when an angular difference between the alignment vectors of the domains adjacent to each other is 90°.

FIG. 8 is a schematic plan view illustrating an example of a pixel electrode including slits disposed at a boundary between a second domain and a third domain.

FIG. 9 is a graph comparing simulation results of a transmittance of a domain boundary region in a case that a center slit is not provided and in a case that a center slit having a slit width of 4 μm is provided.

FIG. 10 is a schematic plan view illustrating an example of a pixel electrode with a fine slit disposed on an electrode edge closer to a head of a liquid crystal director.

FIG. 11 is a schematic plan view illustrating an example of a pixel electrode in which a region having a low electrode density is provided at an electrode edge, and corresponds to a case in that two center slits are disposed in a row at a boundary between a second domain and a third domain.

FIG. 12 is a schematic plan view illustrating an example of a pixel electrode in which a region having a low electrode density is provided at an electrode edge, and corresponds to a case in that two center slits are disposed staggered at a boundary between a second domain and a third domain.

FIG. 13 is a schematic plan view illustrating an example of a pixel electrode in which a region having a low electrode density is provided at an electrode edge, and corresponds to a case in that two center slits are disposed staggered at a boundary between a second domain and a third domain.

FIG. 14 is a schematic plan view illustrating an example of a pixel electrode in which a region having a low electrode density is provided at an electrode edge, and corresponds to a case in that one center slit is disposed at a boundary between a second domain and a third domain.

FIG. 15 is a schematic plan view illustrating an example of a pixel electrode in which a region having a low electrode density is provided at an electrode edge, and illustrates examples of shapes of a slit region in first and second configurations.

FIG. 16 is a schematic plan view illustrating an example of a pixel electrode in which a region having a low electrode density is provided at an electrode edge, and illustrates an example in which a solid electrode positioned near a tail of a liquid crystal director is eliminated in a fourth configuration.

FIG. 17 is a schematic plan view illustrating an example of a pixel electrode in which a region having a low electrode density is provided at an electrode edge, and illustrates an example in which a solid electrode is not provided in a vicinity of a center slit between a second domain and a third domain in a fourth configuration.

FIG. 18(a) is a graph showing changes in electrode density in a longitudinal direction at or near the boundary between the second domain and the third domain of the pixel electrode illustrated in FIG. 17, and FIG. 18(b) is a graph showing changes in electrode density in the longitudinal direction at or near the boundary between the second domain and the third domain of the pixel electrode illustrated in FIG. 16.

FIG. 19 is a schematic plan view illustrating examples of a pixel electrode in which a region having a low electrode density is provided at an electrode edge, and illustrates examples in which, in a vicinity of a slit between a second domain and a third domain in a fourth configuration, an electrode connecting portion is provided and a solid electrode is not provided.

FIG. 20 is a schematic plan view illustrating examples of a pixel electrode in which a region having a low electrode density is provided at an electrode edge, and illustrates examples in which a solid electrode is not provided in the vicinity of a slit between a second domain and a third domain in a fourth configuration, and a wide portion is provided to the slit.

FIG. 21 is a schematic plan view illustrating examples of a pixel electrode in which a region having a low electrode density is provided at an electrode edge, and illustrates examples in which a solid electrode is not provided in the vicinity of slits between a second domain and a third domain in a fourth configuration, and the positions of the slits are staggered on the left and right of the pixel electrode.

FIG. 22 is a schematic plan view illustrating examples of a pixel electrode in which a region having a low electrode density is provided at an electrode edge, and illustrates examples in which a solid electrode is not provided in the vicinity of slits between a second domain and a third domain in a fourth configuration, and the positions of the slits are staggered on the left and right of the pixel electrode.

FIG. 23 is a schematic plan view illustrating an example of a pixel electrode in which a region having a low electrode density is provided at an electrode edge, and illustrates an example in which a solid electrode is not provided in the vicinity of a slit between a second domain and a third domain in a fourth configuration, and slits are arranged on an extended line of a branch portion of the pixel electrode.

FIG. 24 is a graph illustrating a relationship between a pixel density (unit: ppi) and a mode efficiency ratio of a liquid crystal display panel of the embodiment.

FIG. 25 is a plan view schematically illustrating tilt azimuthal directions of liquid crystal molecules in a liquid crystal layer of a conventional liquid crystal display panel including four domains.

FIG. 26 is a graph showing a relationship between a width of a slit and a transmittance (relative transmittance ratio) of a dark line portion under domain boundary conditions B, D.

FIG. 27 is a graph showing a relationship between a width of a slit and a transmittance (relative transmittance ratio) of a dark line portion under domain boundary conditions A, C, and E.

FIG. 28 is a plan view schematically illustrating a relationship between an alignment pattern and a dark line pattern.

FIG. 29 is a table showing a relationship between an electrode width (Line) between fine slits and a width (Space) of the fine slit and a mode efficiency in a case that a pixel pitch is 180 μm.

FIG. 30 is a table showing a relationship between an electrode width (Line) between fine slits and a width (Space) of the fine slit and a mode efficiency in a case that a pixel pitch is 240 μm.

FIG. 31 is a graph showing a relationship between a width (Space) of a fine slit and a mode efficiency in a case that a pixel pitch is 180 μm.

FIG. 32 is a graph showing a relationship between a width (Space) of a fine slit and a mode efficiency in a case that a pixel pitch is 240 μm.

FIG. 33 is a graph showing a relationship between a pitch (Line+Space) of a fine slit and a mode efficiency in a case that a pixel pitch is 180 μm.

FIG. 34 is a graph showing a relationship between a pitch (Line+Space) of a fine slit and a mode efficiency in a case that a pixel pitch is 240 μm.

FIG. 35 is a schematic view illustrating an example of a photo-alignment processing device.

FIG. 36 is a diagram illustrating an example of a photo-alignment processing step using a photo-alignment processing device.

FIG. 37(a) is an explanatory view of a photo-alignment process of a TFT substrate (first substrate), FIG. 37(b) is an explanatory view of a photo-alignment process of a CF substrate (second substrate), and FIG. 37(c) is an explanatory view of a state after the TFT substrate and the CF substrate, which are subjected to the photo-alignment process, were bonded.

FIG. 38 is a schematic plan view illustrating an example of a TFT substrate included in a liquid crystal display panel described in PTL 3.

FIG. 39 is a schematic plan view illustrating an example of tilt azimuthal directions of liquid crystal molecules in a liquid crystal layer in the liquid crystal display panel described in PTL 3.

### DESCRIPTION OF EMBODIMENTS

Embodiments of the present invention will be described hereinafter. The present invention is not limited to the contents described in the following embodiments, and appropriate design changes can be made within a scope that satisfies the configuration of the present invention.

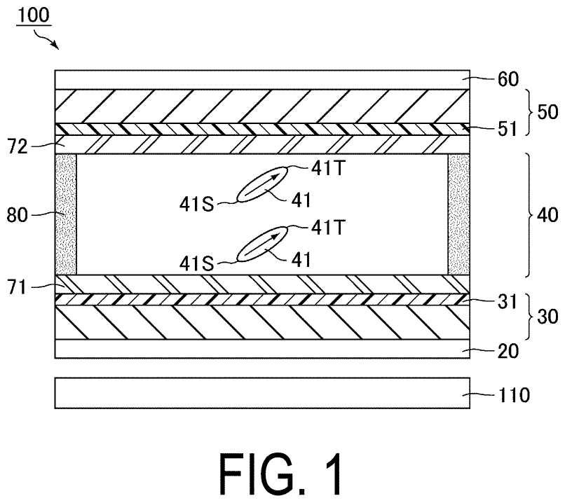

FIG. 1 is a cross-sectional view schematically illustrating an example of a liquid crystal display device of an embodiment. As illustrated in FIG. 1, the liquid crystal display device in the present embodiment includes a liquid crystal display panel 100 and a backlight 110 disposed on a back face side of the liquid crystal display panel 100. The liquid crystal display panel 100 includes a back face-side polarizer 20, a first substrate 30 including a plurality of pixel electrodes 31 and a first photo-alignment film 71, a liquid crystal layer 40 containing liquid crystal molecules 41, a second substrate 50 including a second photo-alignment film 72 and a counter electrode (common electrode) 51, and a display surface-side polarizer 60, in this order. Further, the liquid crystal display panel 100 includes a sealing member 80 around the liquid crystal layer 40.

First, a display method of the liquid crystal display device of the present embodiment will be described. In the liquid crystal display device in the present embodiment, light is incident on the liquid crystal display panel 100 from the backlight 110, and an amount of light passing through the liquid crystal display panel 100 is controlled by switching the alignment of the liquid crystal molecules 41 in the liquid crystal layer 40. The alignment of the liquid crystal molecules 41 is switched by applying voltage to the liquid crystal layer 40 using the plurality of pixel electrodes 31 and the counter electrode 51. When the voltage applied to the liquid crystal layer 40 is less than a threshold value (at the time of applying no voltage), the initial alignment of the liquid crystal molecules 41 is regulated by the first photo-alignment film 71 and the second photo-alignment film 72.

At the time of applying no voltage, the liquid crystal molecules 41 are aligned substantially perpendicular to the first substrate 30 and the second substrate 50. Here, the term “substantially perpendicular” means that the liquid crystal molecules 41 are aligned slightly tilted relative to the first substrate 30 and the second substrate 50 due to the photo-alignment process performed on the first photo-alignment film 71 and the second photo-alignment film 72. A pre-tilt angle of the liquid crystal molecules 41 relative to the first substrate 30 and the second substrate 50 at the time of applying no voltage is preferably greater than or equal to 85° and less than 90°. In a case that the voltage is applied between the pixel electrode 31 and the counter electrode 51, a vertical electric field occurs in the liquid crystal layer 40, and the liquid crystal molecules 41 are further tilted and aligned while the tilt azimuthal direction is maintained from the time of applying no voltage.

In the present specification, the tilt azimuthal directions of the liquid crystal molecules 41 will be described as appropriate using an alignment vector in which, in a plan view of the liquid crystal display panel 100, a major axis edge of the liquid crystal molecules 41 closer to the first substrate 30 is set to a start point (hereinafter, also referred to as “a tail of a liquid crystal director”) 41S, and a major axis edge of the liquid crystal molecules 41 closer to the second substrate 50 is set to an end point (hereinafter also referred to as “a head of the liquid crystal director”) 41T. Note that the alignment vector is in the same direction as the tilt azimuthal direction of the liquid crystal molecules 41 relative to the first photo-alignment film 71 closer to the first substrate 30, and is in an direction opposite to the tilt azimuthal direction of the liquid crystal molecules 41 relative to the second photo-alignment film 72 closer to the second substrate 50. In the present specification, the term “azimuthal direction” means a direction in a view projected onto a substrate plane without consideration of an inclination angle (a polar angle, pre-tilt angle) from a normal direction of the substrate plane. Further, the liquid crystal molecules 41 are aligned substantially vertically (slightly tilted) at the time of applying no voltage, and are aligned largely tilted at the time of applying the voltage while the tilt azimuthal direction at the time of applying no voltage is maintained, and thus the start point 41S and the end point 41T of the alignment vector may be confirmed while voltage is applied to the liquid crystal layer 40.

The first photo-alignment film 71 and the second photo-alignment film 72 are each a photo-alignment film in which a photo-alignment film material is deposited, and a photo-alignment process is performed thereon to cause it to exhibit a function of aligning the liquid crystal molecules 41 in a specific direction. The photo-alignment film material refers to a material in which a structural change generates when irradiated with light (electromagnetic waves) such as ultraviolet light or visible light, and thereby a property of regulating the alignment of the liquid crystal molecules 41 near a position where the structural change generates (alignment regulation force) is exhibited, and to general materials in which a level and/or direction of the alignment regulation force changes due to the structural change. For example, the photo-alignment film material includes a photoreactive site in which a reaction such as dimerization (dimer formation), isomerization, photo Fries transition, or decomposition is generated by light irradiation. Examples of the photo-reactive sites (functional groups) that dimerize and isomerize by light irradiation include cinnamate, cinnamoyl, 4-chalcone, coumarin, and stilbene. Examples of the photo-reactive sites (functional groups) that isomerize by light irradiation include azobenzene. Examples of the photo-reactive sites which are photo-Fries rearranged by light irradiation include phenolic ester structures. Examples of the photo-reactive sites which are decomposed by light irradiation include a dianhydride containing a cyclobutane ring such as 1,2,3,4-cyclobutanetetracarboxylic acid-1,2: 3,4-dianhydride (CBDA). Further, preferably the photo-alignment film material exhibits vertical alignability that can be used in a vertical alignment mode. Examples of the photo-alignment film material include polyamides (polyamic acids), polyimides, polysiloxane derivatives, methyl methacrylate, and polyvinyl alcohol including the photoreactive site.

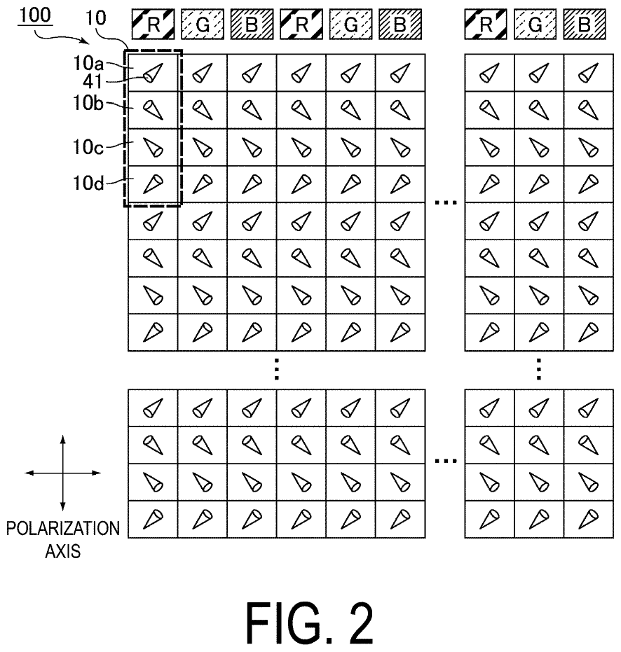

FIG. 2 is a plan view schematically illustrating tilt azimuthal directions of the liquid crystal molecules in the liquid crystal layer of the embodiment. As illustrated in FIG. 2, the liquid crystal display panel 100 of the present embodiment includes a plurality of pixels 10 arranged in a matrix shape. As used herein, the term “pixel” means a display unit region overlapping with a single pixel electrode 31, and a pixel overlapping with a color filter of R (red), a pixel overlapping with a color filter of G (green), and a pixel overlapping with the color filter of B (blue) are provided. In FIG. 2, a portion surrounded by a dotted line is one pixel. In the present embodiment, the second substrate 50 provided with color filters arranged in the order of red (R), green (G), and blue (B) in each column is used.

A plurality of domains having different alignment vectors are provided in the pixel 10. These domains may be formed by varying the photo-alignment process performed on the first photo-alignment film 71 and the second photo-alignment film 72 from each other. When the voltage is applied to the liquid crystal layer 40, the liquid crystal molecules 41 are aligned tilted so as to be matched with the alignment vector of each domain.

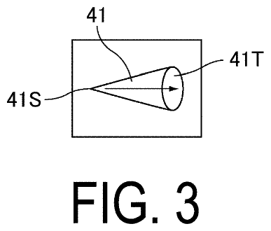

In FIG. 2, to clearly illustrate the tilt azimuthal direction of the liquid crystal molecules 41, the liquid crystal molecules 41 are represented by pins (cones), a bottom face of the cone is positioned near the second substrate 50 (near observer), and a vertex of the cone is positioned near the first substrate 30. FIG. 3 is a diagram for explaining a relationship between the tilt azimuthal direction of the liquid crystal molecules and the alignment vector.

As illustrated in FIG. 2, the plurality of domains include a first domain 10a, a second domain 10b, a third domain 10c, and a fourth domain 10d disposed in this order in the longitudinal direction of a display unit region (pixel) overlapping with a single pixel electrode 31. From the perspective of achieving a favorable viewing angle characteristic, the alignment vector of the first domain 10a, the alignment vector of the second domain 10b, the alignment vector of the third domain 10c, and the alignment vector of the fourth domain 10d are a combination of four alignment vectors oriented in directions difference from one another by 90°. Further, the alignment vector of the first domain 10a and the alignment vector of the second domain 10b have a relationship in which the end points face each other and the alignment vectors are orthogonal to each other (forming an angle of substantially 90°) (hereinafter also referred to as “domain boundary condition A”). The alignment vector of the second domain 10b and the alignment vector of the third domain 10c have a relationship in which the start points face each other and the alignment vectors are parallel with each other (forming an angle of substantially 180°) (hereinafter also referred to as “domain boundary condition B”). The alignment vector of the third domain 10c and the alignment vector of the fourth domain 10d have a relationship in which the end points face each other and the alignment vectors are orthogonal to each other (forming an angle of substantially 90°) (domain boundary condition A). Note that the alignment vector of each domain can be determined by the orientation of the liquid crystal molecules 41 positioned at a center of the domain in a plan view and positioned in the center of the liquid crystal layer in cross-sectional view. Further, in the present specification, “orthogonal to each other (forming an angle of substantially 90°)” means substantially orthogonal within a range in which the effect of the present invention can be achieved, specifically, forming an angle from 75 to 105°, preferably forming an angle from 80° to 100°, and more preferably forming an angle from 85° to 95°. In the present specification, “parallel with each other (forming an angle of substantially 180°)” means substantially parallel within a range in which the effect of the present invention can be achieved, specifically, forming an angle from −15 to +15°, preferably forming an angle from −10° to +10°, and more preferably forming an angle from −5° to +5°.

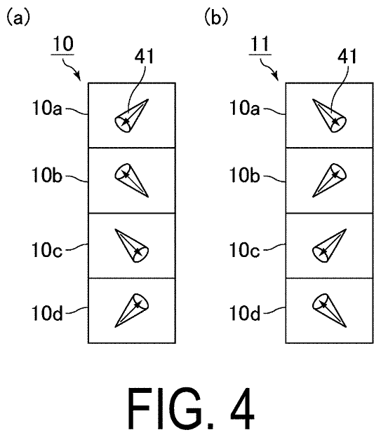

FIG. 4 is a diagram illustrating examples of pixels in which a first domain, a second domain, a third domain, and a fourth domain satisfy a suitable relationship between alignment vectors. As illustrated in FIG. 4, examples of pixels in which a suitable relationship between alignment vectors is satisfied include the pixel 10 (same as in FIG. 2) illustrated in FIG. 4(a) and a pixel 11 illustrated in FIG. 4(b).

Note that in the first domain 10a, the second domain 10b, the third domain 10c, and the fourth domain 10d, an inter-substrate twist angle of the liquid crystal molecules 41 is preferably 45° or less, and more preferably substantially 0°. That is, in the first domain 10a, the second domain 10b, the third domain 10c, and the fourth domain 10d, an angle between the tilt azimuthal direction of the liquid crystal molecules 41 relative to the first photo-alignment film 71 closer to the first substrate 30 and the tilt azimuthal direction of the liquid crystal molecules 41 relative to the second photo-alignment film 72 closer to the second substrate 50 is preferably 45° or less, and more preferably substantially 0°.

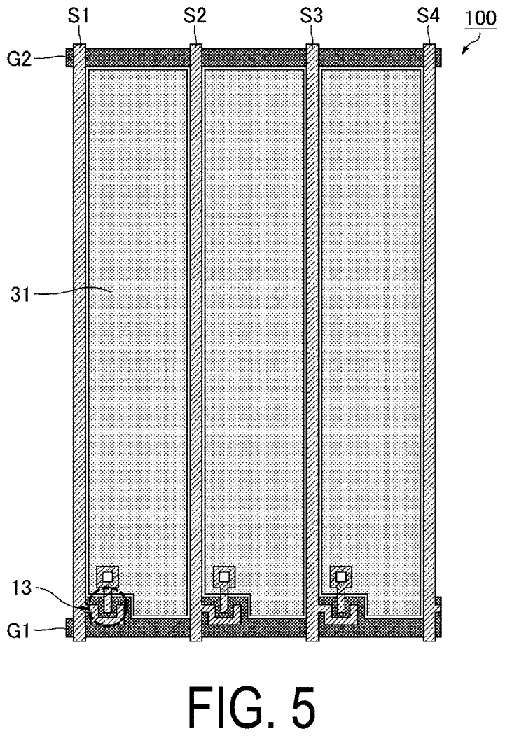

Next, an overview of a configuration of the liquid crystal display device of the present embodiment will be described. The first substrate 30 may be an active matrix substrate (TFT substrate), for example. The TFT substrate can be one commonly used in the field of liquid crystal display panels. FIG. 5 is a plan view schematically illustrating an electrode and wiring line structure of the first substrate according to the embodiment. The TFT substrate may have a configuration including on a transparent substrate, in a plan view thereof, a plurality of gate signal lines G1, G2 in parallel; a plurality of source signal lines S1, S2, S3, S4 extending in a direction orthogonal to the gate signal lines and formed parallel with each other; active elements such as TFTs 13 disposed at intersections of the source signal lines and the gate signal lines; and pixel electrodes 31 disposed in a matrix shaped manner in regions defined by the source signal lines and the gate signal lines. A capacitance wiring line may be disposed parallel with the gate signal lines G.

The TFT formed of an oxide semiconductor is preferably used, channel thereof being formed in the oxide semiconductor. A compound (In—Ga—Zn—O) formed of indium (In), gallium (Ga), zinc (Zn), and oxygen (O), a compound (In—Tin—Zn—O) formed of indium (In), tin (Tin), zinc (Zn), and oxygen (O), a compound (In—Al—Zn—O) formed of indium (In), aluminum (Al), zinc (Zn), and oxygen (O), or the like may be used as the oxide semiconductor.

Each of the pixel electrodes 31 illustrated in FIG. 5 is disposed overlapping with the first domain 10a, the second domain 10b, the third domain 10c, and the fourth domain 10d. Thus, when the voltage is applied to the liquid crystal layer 40, an electric field having the same magnitude is applied in a thickness direction of the liquid crystal layer 40 in the first domain 10a, the second domain 10b, the third domain 10c, and the fourth domain 10d.

The second substrate 50 includes the counter electrode 51, and may be, for example, a color filter substrate (CF substrate). The color filter substrate can be one commonly used in the field of liquid crystal display panels.

Examples of the configuration of the color filter substrate include a configuration in which a black matrix formed into a lattice shape, a lattice, that is, the color filter formed inside the pixel, and the like are provided on the transparent substrate. The black matrix may be formed into the lattice shape in each pixel while overlapping with the boundary of the pixel, or also formed into the lattice shape in each half pixel while crossing the center of one pixel along the transverse direction. In a case that the black matrix overlapping with the region where a dark line occurs is formed, it is possible to make the dark line less likely to be observed.

The counter electrode 51 is disposed facing the pixel electrode 31 with the liquid crystal layer 40 interposed therebetween. The vertical electric field is formed between the counter electrode 51 and the pixel electrodes 31 and the liquid crystal molecules 41 are tilted, which allows the display to be performed. Color filters may be disposed in the order of red (R), green (G), and blue (B), in the order of yellow (Y), red (R), green (G), and blue (B), or in the order of red (R), green (G), blue (B), and green (G), in each column, for example.

The counter electrode 51 is preferably a planar electrode. The counter electrode 51 may be a transparent electrode, and can be formed of, for example, a transparent conductive material such as indium tin oxide (ITO), indium zinc oxide (IZO), zinc oxide (ZnO), or tin oxide (SnO), or an alloy thereof.

In the liquid crystal display panel 100 of the present embodiment, the first substrate 30 and the second substrate 50 are bonded to each other by the sealing member 80 provided to surround the liquid crystal layer 40, and thus the liquid crystal layer 40 is held in a predetermined region. An epoxy resin containing an inorganic or organic filler and a curing agent, or the like may be used as the sealing member 80, for example.

Further, in the present embodiment, a Polymer Sustained Alignment (PSA) technique may be used. In the PSA technique, a gap between the first substrate 30 and the second substrate 50 is filled with a liquid crystal composition containing a photopolymerizable monomer, the liquid crystal layer 40 is subsequently irradiated with light to polymerize the photopolymerizable monomer, a polymer is thus formed on the surfaces of the first photo-alignment film 71 and the second photo-alignment film 72, and the initial tilt (pre-tilt) of the liquid crystal is fixed by the polymer.

A polarization axis of the back face-side polarizer 20 and a polarization axis of the display surface-side polarizer 60 may be orthogonal to each other. Note that the polarization axis may be an absorption axis of the polarizer or a transmission axis of the polarizer. Typically, the back face-side polarizer 20 and the display surface-side polarizer 60 are those obtained by causing a polyvinyl alcohol (PVA) film to adsorb an anisotropic material such as a dichroic iodine complex and causing the anisotropic material to be aligned. Usually, a protection film such as a triacetyl cellulose film is laminated on both sides of the PVA film, and the PVA film puts to practical use. Note that an optical film such as a retardation film may be disposed between the back face-side polarizer 20 and the first substrate 30 and between the display surface-side polarizer 60 and the second substrate 50.

The backlight 110 is not particularly limited to a specific light as long as the backlight emits light including visible light, and may be any backlight that emits the light including only the visible light, or any backlight that emits the light including both the visible light and the ultraviolet light. A backlight that emits white light is suitably used in order to make color display by the liquid crystal display device possible. For example, a light emitting diode (LED) is suitably used as a type of the backlight. Note that, in the present specification, “visible light” means light (electromagnetic wave) having a wavelength that is greater than or equal to 380 nm and less than 800 nm.

In addition to the liquid crystal display panel 100 and the backlight 110, the liquid crystal display device of the present embodiment includes a plurality of members such as an external circuit such as a tape-carrier package (TCP) and a printed circuit board (PCB); an optical film such as a viewing angle increasing film and a luminance improving film; and a bezel (frame). Some components may be incorporated into another component. Components other than those described above are not particularly limited to specific components and, because such components can be those commonly used in the field of liquid crystal display devices, descriptions thereof are omitted.

Next, the effect obtained by provision of the liquid crystal display panel 100 of the present embodiment will be described below. Since in the liquid crystal display panel 100 of the present embodiment, a pixel including a plurality of domains is used, an excellent viewing angle characteristic is achieved, the occurrence of dark lines is suppressed, and high light utilization efficiency is achieved. In a case that a pixel including a plurality of domains is used, a region where the alignment of the liquid crystal molecules 41 is discontinuous may occur at the boundary between the domains adjacent to each other. In such a region, because the liquid crystal molecules 41 cannot be aligned in the intended direction, the light cannot be sufficiently transmitted during display, and the region is recognized as a dark portion. The dark portion formed in a linear shape is called a dark line. In a case that a dark line occurs, a luminance of the pixels decreases, and thus the light utilization efficiency of the liquid crystal display panel decreases. Further, in a case that dark lines occur in different positions on a pixel-by-pixel basis, a uniformity of the display deteriorates. In contrast, in the liquid crystal display panel 100 of the present embodiment, the alignment vectors of the plurality of domains in the pixel are controlled to a preferable relationship to perform display.

### (1) Suppression of Number of Double Dark Lines

In the liquid crystal display panel 100 of the present embodiment, at two of the three boundaries between adjacent domains present in one pixel, an angular difference between the alignment vectors of the domains adjacent to each other is 90°. As a result, the number of double dark lines that occur in the pixels can be suppressed, and the light utilization efficiency and display uniformity can be improved. The principle by which the number of double dark lines is decreased is described below.

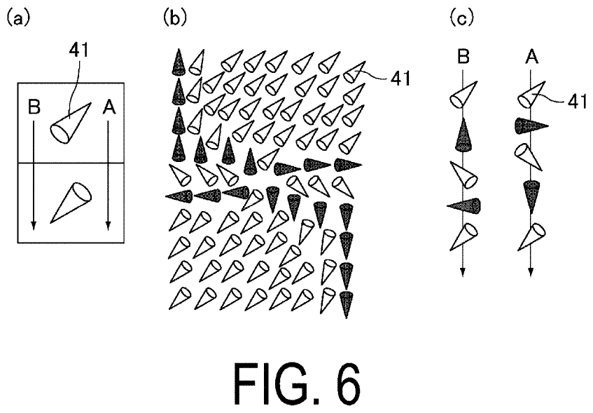

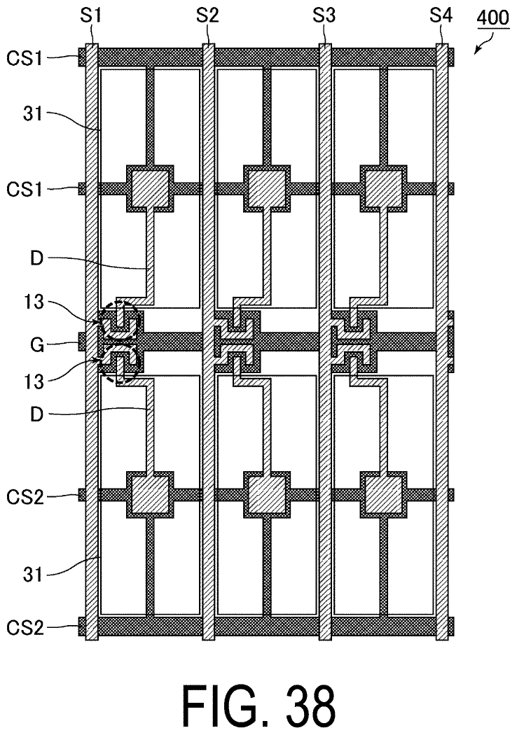

First, in the conventional liquid crystal display panel 400 illustrated in FIG. 38, at two of the three boundaries between adjacent domains present in one pixel, an angular difference between the alignment vectors of the domains adjacent to each other is 180°. In this case, a rotation angle of liquid crystal directors at the boundary is 180°, and thus a double dark lines occur at or near the boundary. FIG. 6(a) is a plan view schematically illustrating tilt azimuthal directions of the liquid crystal molecules corresponding to the alignment vectors of two domains adjacent to each other, FIG. 6(b) is an enlarged view illustrating the tilt azimuthal directions of the liquid crystal molecules in the two domains illustrated in FIG. 6(a) in further detail, and FIG. 6(c) is a diagram illustrating the tilt azimuthal directions of the liquid crystal molecules present along arrows A and B in FIG. 6(a), in a case that an angular difference between the alignment vectors of the domains adjacent to each other is 180°. In FIGS. 6(b) and 6(c), the liquid crystal molecules that become dark portions during display are illustrated in color. In a case that the tilt azimuthal direction of the liquid crystal molecules is parallel with any of the mutually orthogonal absorption axes of the back face-side polarizer 20 and the display surface-side polarizer 60, the liquid crystal molecules are recognized as dark portions. As illustrated in FIGS. 6(b) and 6(c), two dark lines extending in a direction parallel with the boundary occur at or near the boundary. These two dark lines are referred to as double dark lines.

In a case that double dark lines occur, the light utilization efficiency decreases. As a result, the display luminance decreases in a case that the backlight luminance is the same, and the power consumption increases in a case that the luminance of the backlight is increased to maintain the display luminance. Further, the double dark lines are not exactly two separate dark lines, and have an X shape pressed and crushed along the boundary between adjacent domains. Furthermore, because a position of a center point (intersection point) of the X shape is not defined, a position and a size of the dark lines differ on a pixel-by-pixel basis. Therefore, the double dark lines cause the optical characteristics of each pixel to be nonuniform and, as a result, the uniformity of the display when viewed across the entire panel is reduced. The variation in the occurrence of the double dark lines is due to the alignment of the boundary portions of the domains adjacent to each other being dependent on the relationship of the alignment of the domains adjacent to each other, and the like. Such variation in the occurrence of the double dark lines can be prevented by providing a structure for positioning (fixing) the center point (intersection point) of the X shape. For example, the shape of the dark lines can be stabilized by, for example, utilizing a shape of a slit (center slit) including a portion that extends substantially parallel with a domain boundary and an arrangement pattern, described later.

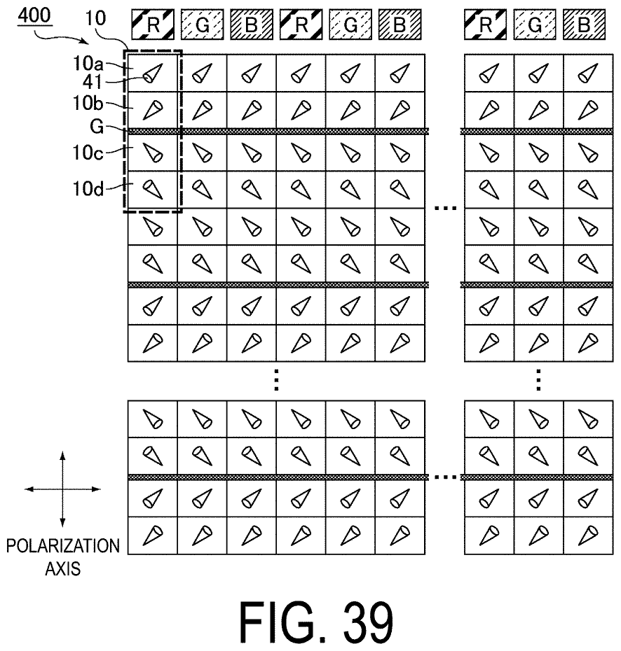

While the number of double dark lines that occur in a pixel is preferably small, in the conventional liquid crystal display panel 400 illustrated in FIG. 39, at two of the three boundaries between adjacent domains present in one pixel, an angular difference between the alignment vectors of the domains adjacent to each other is 180°, and thus two double dark lines occur on a pixel-by-pixel basis.

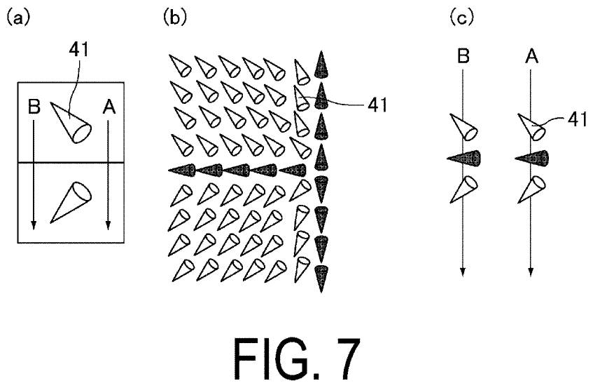

In contrast, in the liquid crystal display panel 100 of the present embodiment, a domain arrangement is devised such that, at two of the three boundaries between adjacent domains present in one pixel, an angular difference between the alignment vectors of the domains adjacent to each other is 90°. That is, at the boundary between the first domain 10a and the second domain 10b, and the boundary between the third domain 10c and the fourth domain 10d, the rotation angle of the liquid crystal directors is controlled to 90° and the occurrence of double dark lines is suppressed. FIG. 7(a) is a plan view schematically illustrating the tilt azimuthal directions of the liquid crystal molecules corresponding to the alignment vectors of two domains adjacent to each other, FIG. 7(b) is an enlarged view illustrating the tilt azimuthal directions of the liquid crystal molecules in the two domains illustrated in FIG. 7(a) in further detail, and FIG. 7(c) is a diagram illustrating the tilt azimuthal directions of the liquid crystal molecules present along arrows A and B in FIG. 7(a), in a case that an angular difference between the alignment vectors of the domains adjacent to each other is 90°. In FIGS. 7(b) and 7(c), the liquid crystal molecules present in the occurrence region of double dark lines are also illustrated in color. As is clear from FIG. 7, compared to a case that the angular difference between the alignment vectors of the domains adjacent to each other is 180°, when the angular difference between the alignment vectors of the domains adjacent to each other is 90°, the tilt azimuthal directions of the liquid crystal molecules are seldom parallel with any of the mutually orthogonal absorption axes of the back face-side polarizer 20 and the display surface-side polarizer 60, and thus the occurrence of double dark lines can be suppressed.

In the liquid crystal display panel 100 of the present embodiment, at only the boundary between the second domain 10b and the third domain 10c among the three boundaries of adjacent domains present in one pixel, an angular difference between the alignment vectors of the domains adjacent to each other is 180°, making it possible to suppress the number of double dark lines for each pixel to one.

### (2) Substantial Elimination of Double Dark Lines

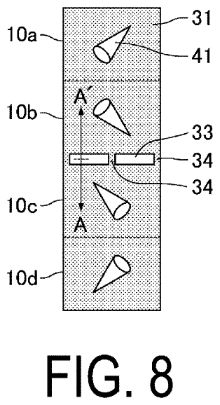

In the liquid crystal display panel 100 of the present embodiment, the pixel electrode 31 is provided with a slit including a portion extending substantially parallel with the domain boundary, making it possible to cause the double dark lines that occur at the boundary between the second domain 10b and the third domain 10c to substantially disappear as well. FIG. 8 is a schematic plan view illustrating an example of a pixel electrode including slits disposed at a boundary between the second domain and the third domain. As illustrated in FIG. 8, when a slit (hereinafter, also referred to as “center slit”) 33 is disposed at the boundary between the second domain 10b and the third domain 10c, electric field distortion caused by the center slit 33 occurs at or near the boundary between the second domain 10b and the third domain 10c. As a result, successive changes in alignment at the boundary between the second domain 10b and the third domain 10c can be intentionally suppressed to 90° or less, and the double dark lines can be substantially eliminated. Further, by providing a joining portion (connecting portion) 34 on both sides of the center slit 33, it is possible to prevent the pixel electrode 31 from being divided into two.

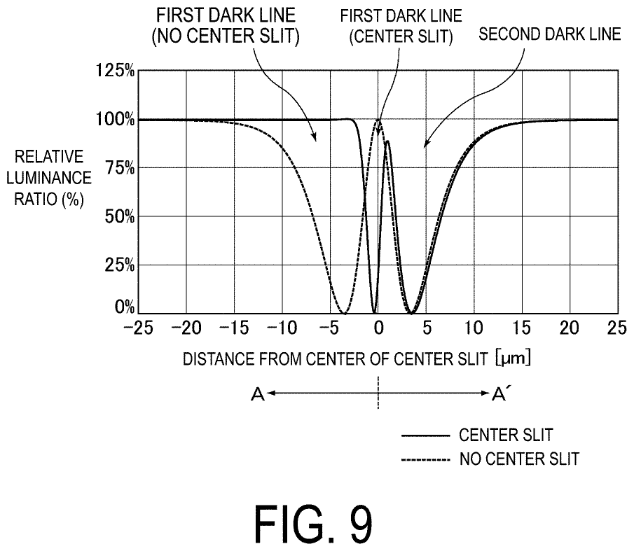

Note that in the present specification, “substantial elimination of the double dark lines” means that the occurrence of double dark lines is not clearly visually recognized, and is a concept encompassing not only a state in which the double dark lines are not formed, such as a case in which all the double dark lines disappear, or a case in which, among the two dark lines constituting the double dark lines, one dark line disappears and only the remaining one dark line is visually recognized; but also a state in which, among the two dark lines constituting the double dark lines, one dark line is less likely to be visually recognized and only the remaining one dark line is visually recognized. In a case that the center slit 33 is provided, the center slit 33 may not result in disappearance of the dark lines constituting the double dark lines when the center slit 33 is thin (has a small slit width), but at least one of the two dark lines is narrowed, making it possible to achieve a higher transmittance in the domain boundary region than when the center slit 33 is not provided, and thus the result can be evaluated as having achieved substantial elimination of the double dark lines. FIG. 9 is a graph comparing simulation results of a transmittance at a domain boundary region in a case that the center slit 33 is not provided and in a case that the center slit 33 having a slit width of 4 μm is provided. The horizontal axis in FIG. 9 indicates a distance from a center of the center slit 33 on a line along “A-A” in FIG. 8. The vertical axis in FIG. 9 indicates a relative luminance ratio when the transmittance of a pixel center portion is 100%. As shown in FIG. 9, while there are two dark lines in a case that the center slit is provided, a width of a first dark line on the left side in FIG. 9 is significantly reduced, and the transmittance at or near −3 μm from the center of the center slit 33 is significantly improved. On the other hand, when the center slit 33 is thick (has a large slit width), the double dark line is eliminated but, because a width of the remaining dark line is thick, the transmittance may be low in the domain boundary region compared to a case in which the center slit 33 is not provided. That is, an optimal value for the width of the center slit 33 exists and, in the domain arrangement of the present embodiment, the width of the center slit 33 provided at the boundary between the second domain 10b and the third domain 10c is preferably from 1 to 8 μm, and more preferably from 2.5 to 6 μm.

On the other hand, the pixel electrode 31 having the shape illustrated in FIG. 5 includes an electrode edge around the pixel, but does not include an electrode edge at the boundary between the second domain 10b and the third domain 10c, and therefore electric field distortion cannot be generated at or near the boundary between the second domain 10b and the third domain 10c when voltage is applied to the pixel electrode 31.

### (3) Elimination of Dark Line Around Pixel

The dark lines that occur in a pixel are not only double dark lines. Dark lines may also occur around the pixel (at or near the electrode edge). From the perspective of improving light utilization efficiency, preferably such dark lines are also caused to disappear. Dark lines around a pixel occur in locations where the head of the liquid crystal director faces the electrode edge. In such a location, the alignment direction of the liquid crystal molecules resulting from electric field distortion at the electrode edge and the alignment direction resulting from the photo-alignment process in the electrode differ by substantially 135° and thus, during the process of both alignments being continuously connected, a portion in which the major axis of the liquid crystal molecules and the absorption axes of the back face-side polarizer 20 and the display surface-side polarizer 60 orthogonal to each other are parallel (or perpendicular) is formed, and portions thereof are recognized as dark lines.

Examples of methods for eliminating dark lines around a pixel includes providing a fine slit at least at an edge of the pixel electrode 31. According to this method, the alignment distortion of the liquid crystal molecules at the edge of the pixel electrode 31 is reduced, and the liquid crystal can be aligned in a desired direction at a position closer to the electric field edge, making it possible to suppress the occurrence of dark lines. Here, “fine slit” refer to a portion in which a plurality of pairs of a slit portion extending in a direction parallel with the desired alignment direction (alignment vector) of the liquid crystal and an electrode portion are formed side by side. Note that each of the slit portions of the fine slit may be narrower than the center slit 33, may have about the same width as that of the center slit 33, or may be thicker than the center slit 33.

Specific examples of the fine slit include the following first to fourth configurations.

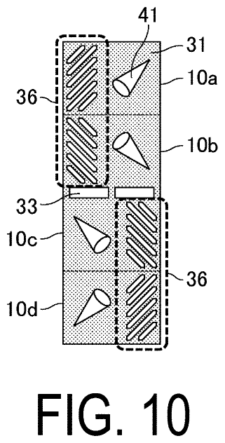

In the first configuration, the fine slit is provided to the electrode edge closer to the head of the liquid crystal director. FIG. 10 is a schematic plan view illustrating an example of a pixel electrode with the fine slit disposed to the electrode edge closer to the head of the liquid crystal director.

In the second configuration, a fine slit 36 is provided not only to the electrode edge, but also along the boundary of adjacent domains that satisfy the domain boundary condition A, and the boundary of the adjacent domains is constituted by a solid electrode. According to the second configuration, due to an action of aligning the liquid crystal contained in the fine slit 36 in the desired alignment direction, an alignment distortion near the domain boundary can be suppressed, and the region where the alignment change occurs at the boundary between the adjacent domains that satisfy the domain boundary condition A becomes narrower, making it possible to narrow the dark lines. The boundary between the adjacent domains is configured by a solid electrode because an inclination of the electric field and a tilt angle (polar angle) component of the alignment of the liquid crystal molecules 41 are aligned. Note that, in the present specification, the term “inclination of the electric field” refers to a change in the electric field generated by a change in electrode density or the like, and indicates an electric field that includes components in a plane perpendicular to the substrate surface and influences an inclination angle (polar angle) of the liquid crystal molecules. In contrast, a change in the electric field generated by the fine slit 36 is referred to as “field distortion”. The fine slit 36 causes electrical potential having a groove shape parallel with the slit portion to be generated and a lateral electric field component parallel with the substrate surface and perpendicular to the slit portion to be generated. The alignment direction of the liquid crystal molecules changes due to this lateral electric field component, and the liquid crystal molecules are aligned in a direction parallel with the slit portion.

In the third configuration, the fine slit 36 is provided to increase an arrangement density of the electrode from the electrode edge toward an electrode inner side (center). According to the third configuration, the discontinuous electric field change at an interface between the region where the fine slit 36 is disposed and the region where the fine slit 36 is not disposed can be suppressed and changes in the electric field can be smoothened, making it possible to improve a response performance, a finger push recovery performance, and the like of the liquid crystal. In addition, because regions where voltages applied to the liquid crystal layer 40 differ from each other can be formed in the pixel electrode 31, a viewing angle improvement effect can also be achieved.

In the fourth configuration, the fine slit 36 is provided across the entire electrode. According to the fourth configuration, discontinuous electric field changes in the pixel electrode 31 can be eliminated, and the response performance, the finger push recovering performance, and the like of the liquid crystal can be improved.

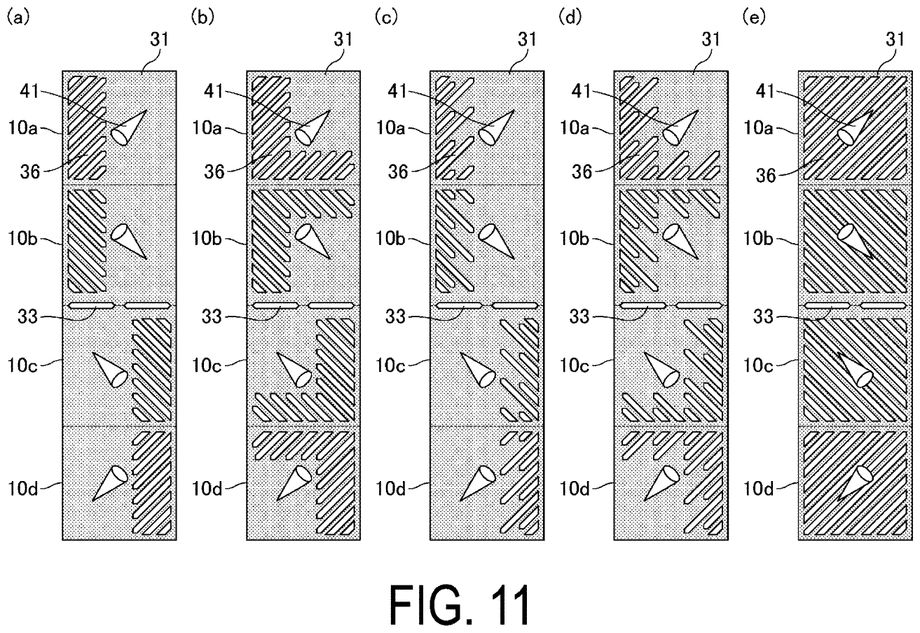

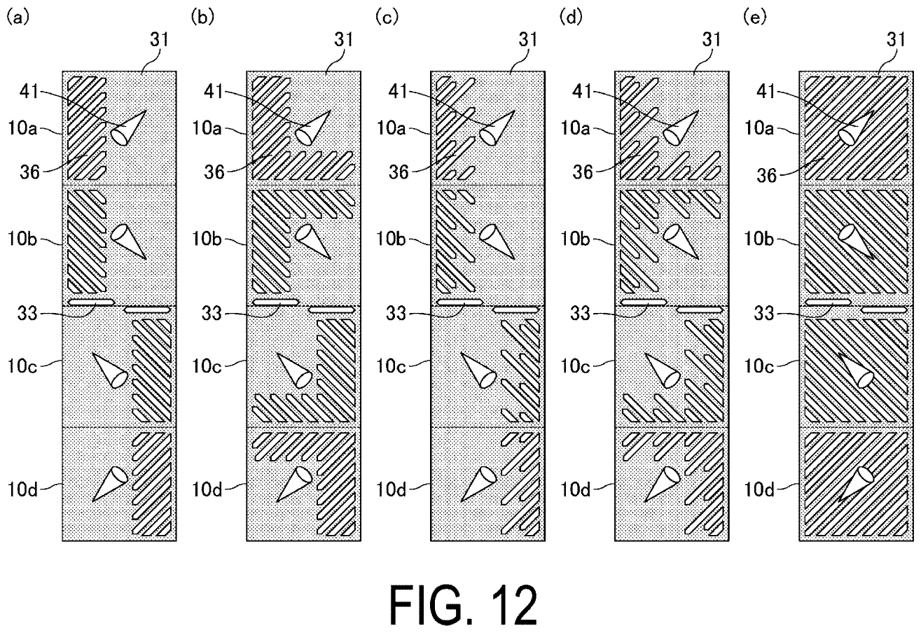

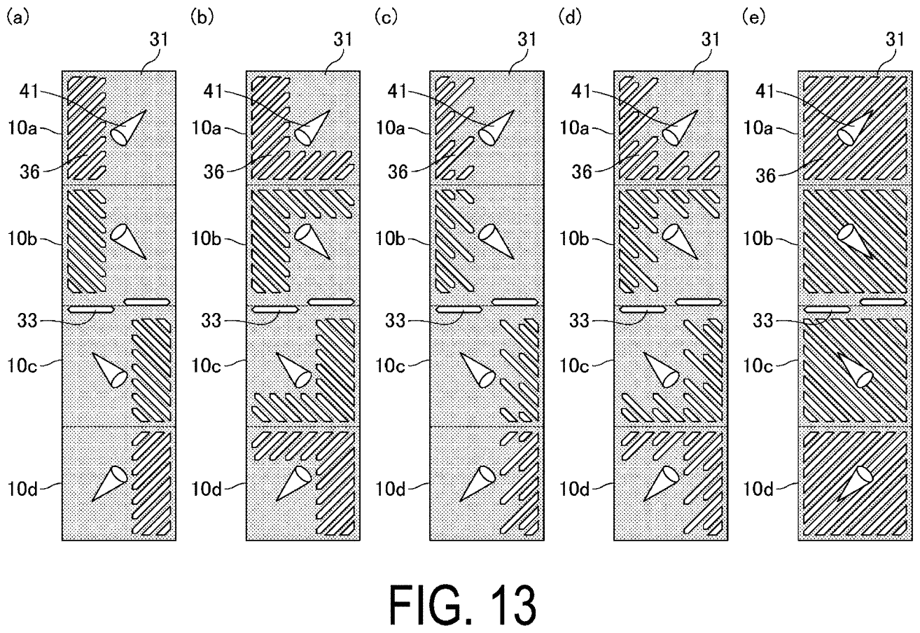

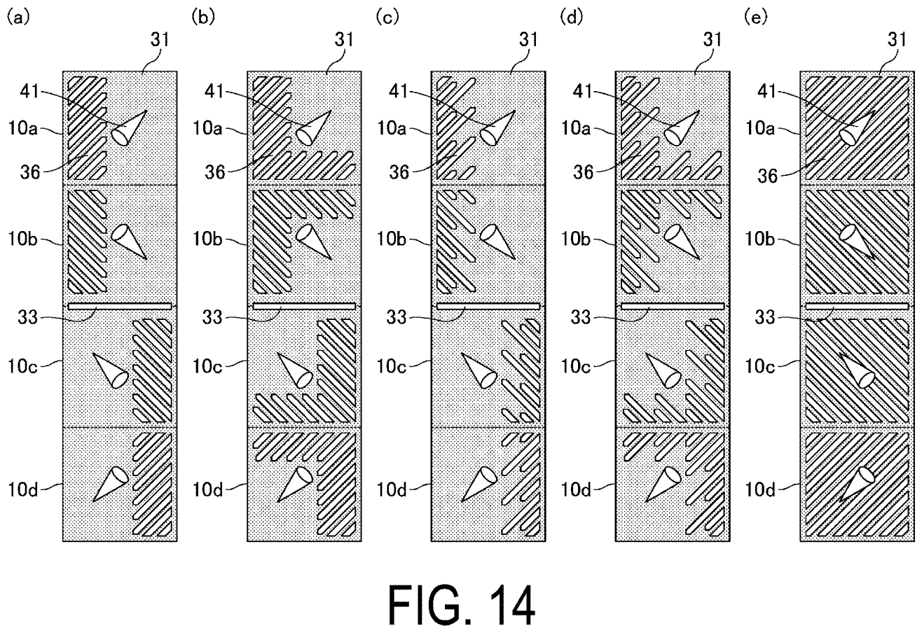

In relation to the first to fourth configurations, FIGS. 11 to 17 and 19 to 23 illustrate schematic plan views of examples of pixel electrodes in which regions having a low electrode density are provided at the electrode edge. FIG. 11 corresponds to a case in that two of the center slits 33 are disposed in a row at the boundary between the second domain and the third domain. FIGS. 12 and 13 correspond to a case in that two of the center slits 33 are disposed staggered at the boundary between the second domain and the third domain. FIG. 14 corresponds to a case in that one center slit 33 is disposed at the boundary between the second domain and the third domain.

The corresponding relationship between the pixel electrodes illustrated in FIGS. 11 to 14 and the first to fourth configurations is as follows.

FIG. 11(a): First configuration

FIG. 11(b): First and second configurations

FIG. 11(c): First and third configurations

FIG. 11(d): First, second, and third configurations

FIG. 11(e): First and fourth configurations

FIG. 12(a): First configuration

FIG. 12(b): First and second configurations

FIG. 12(c): First and third configurations

FIG. 12(d): First, second, and third configurations

FIG. 12(e): First and fourth configurations

FIG. 13(a): First configuration

FIG. 13(b): First and second configurations

FIG. 13(c): First and third configurations

FIG. 13(d): First, second, and third configurations

FIG. 13(e): First and fourth configurations

FIG. 14(a): First configuration

FIG. 14(b): First and second configurations

FIG. 14(c): First and third configurations

FIG. 14(d): First, second, and third configurations

FIG. 14(e): First and fourth configurations

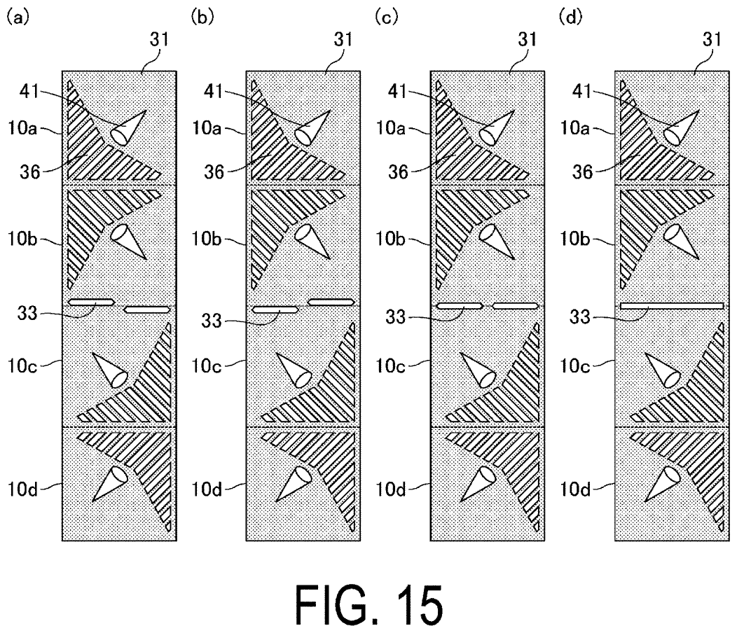

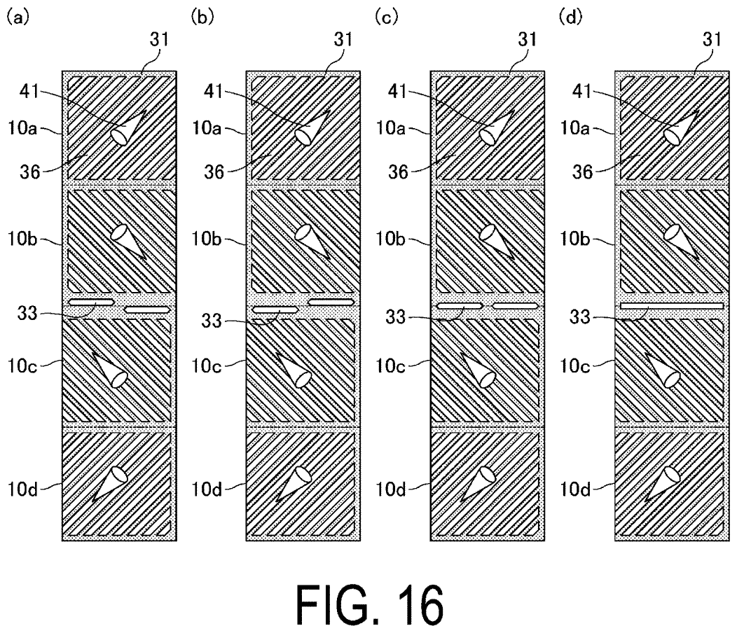

FIG. 15 illustrates examples of shapes of a slit region in the first and second configurations. FIG. 16 illustrates an example in which the solid electrode positioned near the tail of the liquid crystal director is eliminated in the fourth configuration. According to the pixel electrode 31 illustrated in FIG. 16, the effect of the fine slit 36 can be enhanced and the mode efficiency can be further improved.

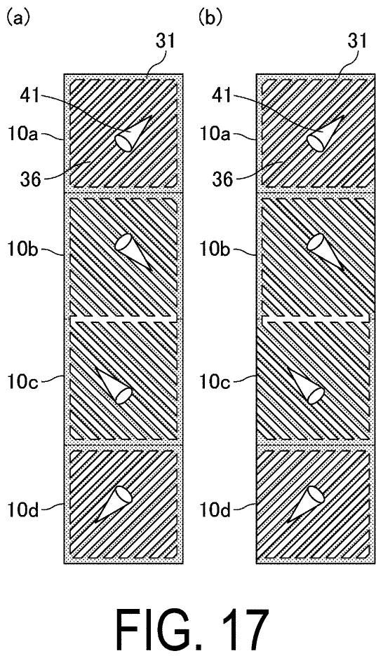

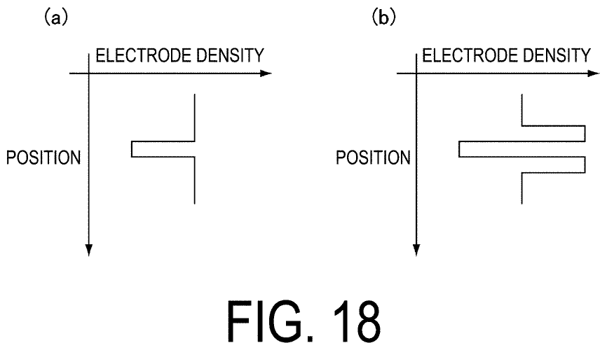

FIG. 17 illustrates an example in which a solid electrode is not provided in a vicinity of the center slit 33 between the second domain and the third domain in the fourth configuration. FIG. 18(a) is a graph showing changes in the electrode density in the longitudinal direction at or near the boundary between the second domain and the third domain of the pixel electrode illustrated in FIG. 17, and FIG. 18(b) is a graph showing changes in the electrode density in the longitudinal direction at or near the boundary between the second domain and the third domain of the pixel electrode illustrated in FIG. 16. As illustrated in the graphs of FIGS. 18(a) and 18(b), the electrode density of the pixel electrode illustrated in FIG. 16 changes such that it increases, decreases, and increases in the longitudinal direction, resulting in a possibility in that the inclination of the electric field and the tilt angle (polar angle) component of the liquid crystal molecular alignment are not aligned, and the alignment of the liquid crystal molecules may become unstable. According to the pixel electrode illustrated in FIG. 17, the electrode density can be monotonically reduced toward the center of the center slit 33 around the center slit 33, and thus the inclination of the electrical field and the tilt angle (polar angle) component of the liquid crystal molecular alignment can be aligned and the alignment of the liquid crystal molecules can be stabilized.

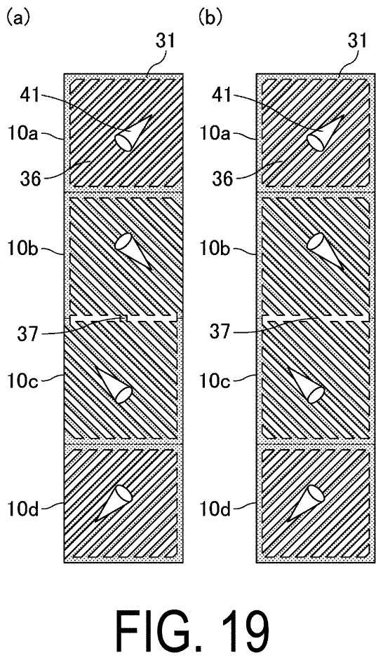

FIG. 19 illustrates examples in which, in the vicinity of the center slit 33 between the second domain and the third domain in the fourth configuration, an electrode connecting portion 37 is provided and the solid electrode is not provided. According to the pixel electrodes illustrated in FIG. 19, yield deterioration due to electrode breakage and the like can be prevented. In addition, the length of the center slit 33 is shortened, which has the effect of stabilizing the shape of the dark lines.

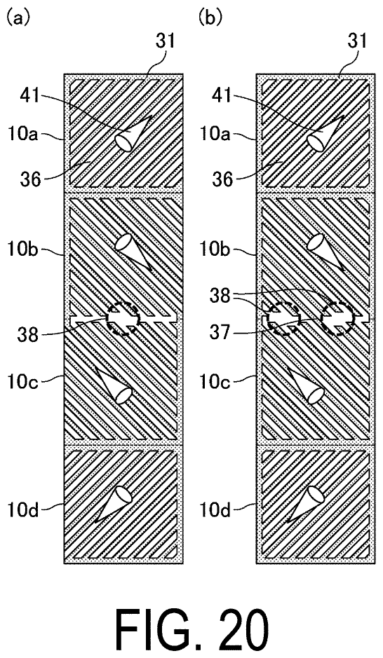

FIG. 20 illustrates examples in which, in the vicinity of the center slit 33 between the second domain and the third domain in the fourth configuration, a wide portion 38 is provided to the center slit 33 and the solid electrode is not provided. The pixel electrode illustrated in FIG. 20(a) is provided with the wide portion 38 at the center of the center slit 33. The pixel electrode illustrated in FIG. 20(b) is provided with an electrode connecting portion 37 and a plurality of wide portions 38. According to the pixel electrodes illustrated in FIG. 20, the shape of the dark lines can be stabilized.

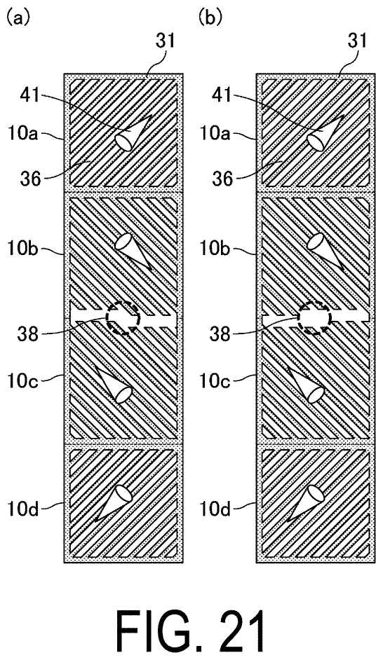

FIG. 21 illustrates examples in which, in the vicinity of the center slits 33 between the second domain and the third domain in the fourth configuration, the positions of the center slits 33 are staggered on the left and right of the pixel electrode and the solid electrode is not provided. The pixel electrodes illustrated in FIG. 21 are each provided with the wide portion 38 in a portion where the center slits 33 on the left and right communicate with each other. According to the pixel electrodes illustrated in FIG. 21, the shape of the dark lines can be stabilized.

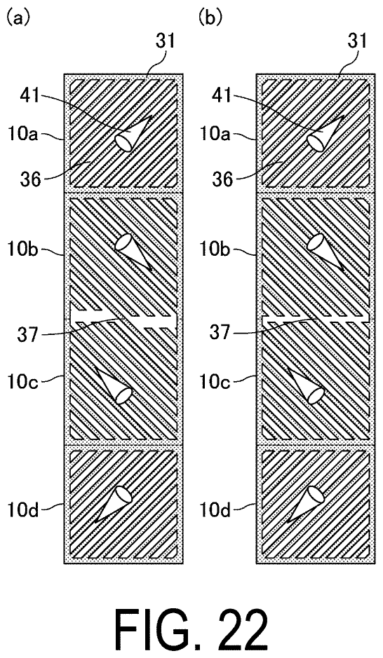

FIG. 22 illustrates examples in which, in the vicinity of the center slits 33 between the second domain and the third domain in the fourth configuration, the positions of the center slits 33 are staggered on the left and right of the pixel electrode, the electrode connecting portion 37 is provided, and the solid electrode is not provided. The pixel electrodes illustrated in FIG. 22 are provided with the electrode connecting portion 37 in a portion where the center slits 33 on the left and right communicate with each other. According to the pixel electrodes illustrated in FIG. 22, the shape of the dark lines can be stabilized.

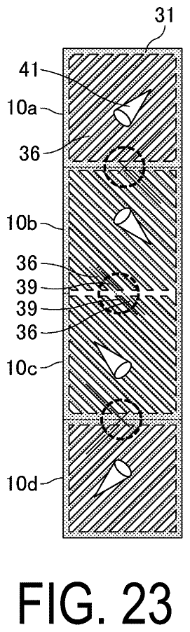

FIG. 23 illustrates an example in which, in the vicinity of the center slit 33 between the second domain and the third domain in the fourth configuration, the fine slit 36 is disposed on an extended line of a branch portion 39 of the pixel electrode and the solid electrode is not provided. According to the pixel electrode illustrated in FIG. 23, a production yield can be improved. Note that, in FIG. 23, the fine slit 36 on the extended line of the branch portion 39 of the pixel electrode is disposed only between the second domain and the third domain; however, by providing the fine slit 36 on the extended line of the branch portion 39 of the pixel electrode is provided to at least one of the three domain boundary portions (between the first domain and the second domain, between the second domain and the third domain, and between the third domain and the fourth domain), a yield improvement effect can also be expected. Since the slits and electrodes are configured not to face each other in the domain boundary portion as in the configuration described above, the following effects can be obtained. In a case that a solid electrode is provided to the domain boundary portion, the solid electrode can be prevented from being broken. In a case that a solid electrode is not provided to the boundary portion, electrodes can be prevented from connecting to each other.

Next, evaluation tests performed on the liquid crystal display panel 100 of the present embodiment will be described.

### (A) Resolution

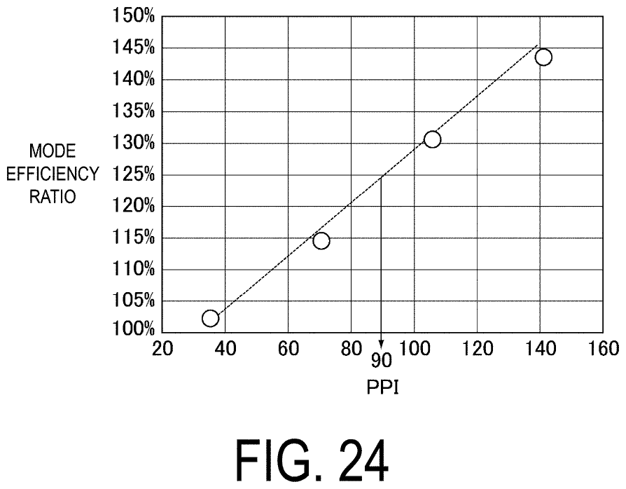

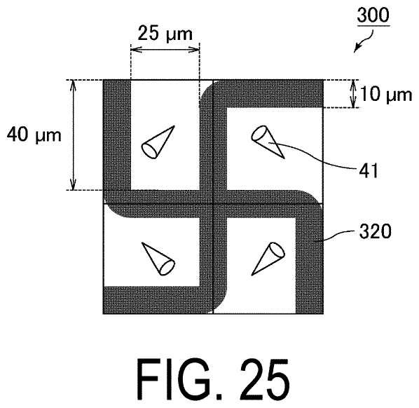

The liquid crystal display panel 100 of the present embodiment preferably has a pixel density (resolution) of 90 ppi or greater. FIG. 24 is a graph illustrating a relationship between a pixel density (unit: ppi) and a mode efficiency ratio of the liquid crystal display panel of the embodiment, and FIG. 25 is a plan view schematically illustrating tilt azimuthal directions of liquid crystal molecules in a liquid crystal layer of a conventional liquid crystal display panel including four domains in a pixel. Here, the term “mode efficiency ratio” refers to the mode efficiency (light transmission efficiency) when compared to a liquid crystal display panel 300 in FIG. 25, and is expressed by the equation below.

Mode efficiency ratio=Mode efficiency of liquid crystal display panel 100 in embodiment/Mode efficiency of liquid crystal display panel 300 in FIG. 25

The graph of FIG. 24 was created by preparing samples of the liquid crystal display panel 100 of the embodiment and the liquid crystal display panel 300 of FIG. 25 with a 35 ppi (pixel pitch: 720 μm), a 71 ppi (pixel pitch: 360 μm), a 106 ppi (pixel pitch: 240 μm), and a 141 ppi (pixel pitch: 180 μm), and measuring the mode efficiency of each sample. As can be seen in FIG. 24, the liquid crystal display panel 100 of the present embodiment, compared to the liquid crystal display panel 300 illustrated in FIG. 25, achieves a mode efficiency ratio that increases in proportion to an increase in resolution. When the pixel density (resolution) is 90 ppi or greater, the mode efficiency ratio is 125% (1.25 times).

### (B) Relationship Between Alignment Vectors and Dark Lines of Adjacent Domains

To optimize the mode efficiency, the relationship between the alignment vectors of the domains and the dark lines produced between adjacent domains or at the pixel edge was evaluated by the following method.

### Measurement Procedure

1. The polarizers were set in a crossed-Nicol state and, with a square wave having a frequency of 30 Hz and a voltage of 7 V applied to the evaluation cell, a micrograph of the pixel was taken. The imaging conditions included an objective lens having a magnification of 10, an ISO sensitivity of ISO200, and an exposure time of ¼ seconds.

2. The captured image was converted by gamma conversion to obtain gray-scale and luminance linearity.

3. From the pixel image, a luminance profile of the pixel in the major axis direction (direction perpendicular to the dark lines) was taken, a profile of the dark line portion was extracted, and a total luminance was calculated.

4. A luminous evaluation was conducted on various dark lines, and a relative luminance ratio was calculated using the luminance of the dark lines under the domain boundary condition A as 1.

### Evaluation Conditions

When the end points of the alignment vectors of adjacent domains face each other and the alignment vectors form an angle of 90° (domain boundary condition A).

When the start points of the alignment vectors of adjacent domains face each other and the alignment vectors form an angle of 180° (domain boundary condition B).

When the end points of the alignment vectors of adjacent domains face each other and the alignment vectors form an angle of 180° (domain boundary condition C).

When the start points of the alignment vectors of adjacent domains face each other and the alignment vectors form an angle of 90° (domain boundary condition D).

When the start points and the end points of the alignment vectors of adjacent domains face each other and the alignment vectors form an angle of 90° (domain boundary condition E).

When the end point of the alignment vector of the domain faces the pixel edge portion (domain boundary condition F).

When the start point of the alignment vector of the domain faces the pixel edge portion (domain boundary condition G).

The evaluation results were as shown in Table 1 below. Note that the results obtained by the image processing and the results obtained by the simulation were substantially the same. Therefore, the following description is made using the results obtained by simulation. It was confirmed that the dark lines of the domain boundary conditions A, D were lightest and effective in enhancing transmittance. Further, the dark line luminance of the pixel edge portion was the same as that under the domain boundary condition A in a case that the end point of the alignment vector of the domain faces the pixel edge portion (domain boundary condition E), and was 1.08 times that under the domain boundary condition A in a case that the start point of the alignment vector of the domain faces the pixel edge portion (domain boundary condition F).

TABLE 1

| Domain boundary condition | Actual value | Simulation value |
|---|---|---|
| A | 1 | 1 |
| B | 0.93 | 0.90 |
| C | 0.95 | 0.90 |
| D | — | 1.00 |
| E | — | 1.01 |
| F | 1.01 | 1.02 |
| G | 1.06 | 1.08 |

### (C) Center Slit 33 Between Adjacent Domains

The present inventors discovered that transmittance at a dark line is improved by providing slits (ITO gaps) having an optimal width at positions directly below the dark line of the pixel electrode 31. According to the simulation, it was confirmed that a mode efficiency improvement effect was not achieved when the width of the slit is narrow or wide, and that there is an optimal width. In the domain arrangement of the present embodiment, the width of the center slit 33 provided at the boundary (domain boundary condition B) between the second domain 10b and the third domain 10c is preferably from 1 to 8 μm, and more preferably from 2.5 to 6 μm.

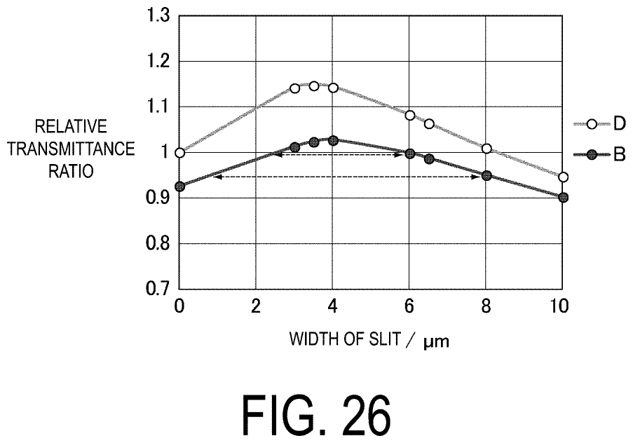

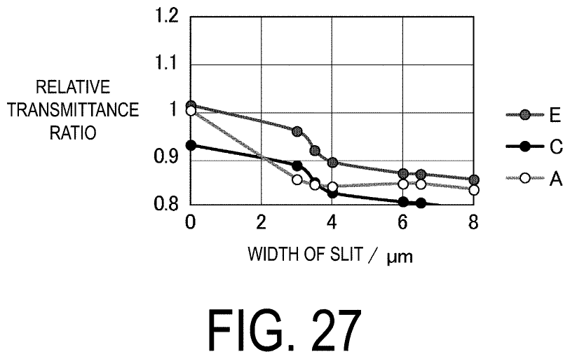

FIG. 26 is a graph showing a relationship between a width of the slit and a transmittance (relative transmittance ratio) of the dark line portion under domain boundary conditions B, D. Further, FIG. 27 is a graph showing a relationship between the width of the slit and the transmittance (relative transmittance ratio) of the dark line portion under domain boundary conditions A, C, E. Note that the relative transmittance ratio indicated by the vertical axis of the graphs of FIGS. 26 and 27 is a ratio in which the transmittance of the dark line portions under the target domain boundary condition is normalized given 1 as the transmittance of the dark line portion under the domain boundary condition A when the slit is not provided. According to FIG. 26, under the domain boundary condition B, slits having a width from 1 to 8 μm were provided, improving the relative transmittance ratio; slits having a width from 2.5 to 6 μm were provided, achieving a transmittance of the dark line portion greater than or equal to that under the domain boundary condition A when a slit was not provided; and the luminance ratio was the highest when slits having a width of 4 μm were provided. Further, according to FIG. 26, under the domain boundary condition D, there was an improvement effect in the range of 0 μm <slit width <8 μm, and the luminance ratio was the highest when slits having a width of 3.5 μm were provided. On the other hand, as illustrated in FIG. 27, under domain boundary conditions A, C, E, the center slit 33 (ITO gap) was provided, reducing the transmittance of the dark line portions.

### (D) Optimal Structure of Alignment Pattern and Slit

In the present embodiment, the first domain 10a, the second domain 10b, the third domain 10c, and the fourth domain 10d disposed in that order along the longitudinal direction of the pixel are adjusted so as to have an array of domain boundary conditions A-B-A. This is because a relationship between the alignment pattern and the dark line pattern and a slit width of the pixel electrode provided at dark lines are optimized, and thus, the display quality can be improved by maximization of the mode efficiency and elimination of the double dark lines.

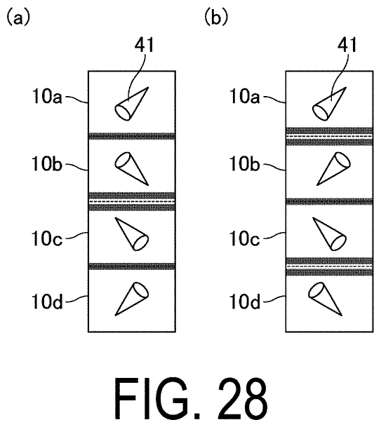

For example, for the pixel having the array of the domain boundary conditions A-B-A illustrated in FIG. 28(a), when the simulation results shown in Table 1 described above are used to find an average luminance of the dark line portion in a case that the center slit 33 having a width of 4 μm is provided at the boundary (domain boundary condition B) between the second domain 10b and the third domain 10c, the average luminance is 1.04 on the basis of Equation (A) below.

(1.00×2+1.04+1.08×2)/5=1.04 (A)

On the other hand, for the pixel having an array of the domain boundary conditions C-D-C illustrated in FIG. 28(b), when the simulation results shown in Table 1 described above are used to find an average luminance of the dark line portion, the average luminance is 0.99 on the basis of Equation (B) below.

(0.90×2+1.00+1.08×2)/5=0.99 (B)

As described above, the pixel having the array of the domain boundary conditions A-B-A is provided with the center slit 33 at the boundary (domain boundary condition B) between the second domain 10b and the third domain 10c, substantially eliminating the double dark lines, and thus making it possible to improve mode efficiency. In a case that the domain boundary condition A is included in the array to narrow a width of dark lines and the slit is provided in the dark line portion under the domain boundary condition B, the luminance is maximized.

### (E) Conditions of Fine Slit 36

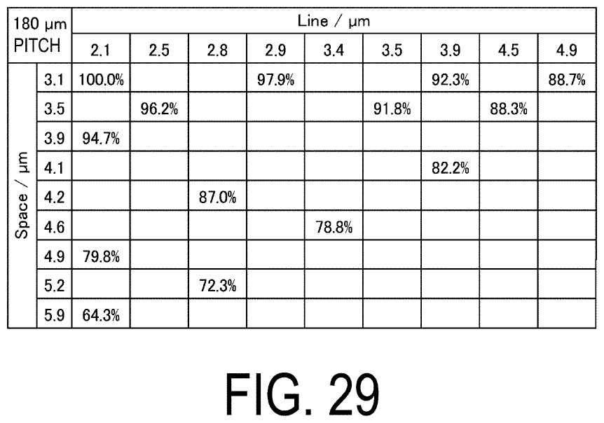

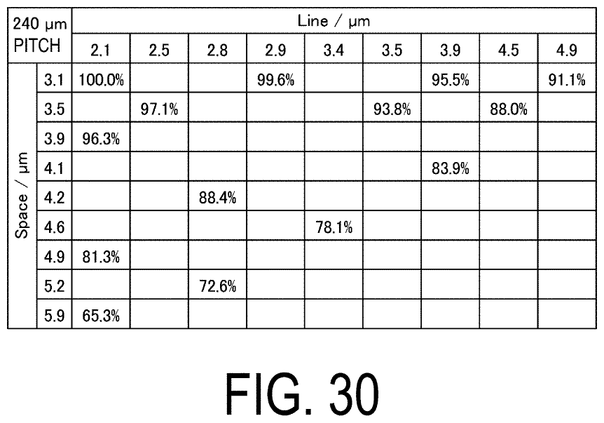

To identify an optimal combination of an electrode width L between the fine slits 36 and a width S of the fine slit 36, the mode efficiency was measured by changing the conditions, namely L and S, for the pixel electrode provided with the fine slit 36 having the shape and arrangement pattern illustrated in FIG. 14(e), and the evaluation results are shown in FIGS. 29 and 30. FIG. 29 is a table showing a relationship between an electrode width (Line) between the fine slits 36 and a width (Space) of the fine slit 36 and a mode efficiency in a case that a pixel pitch is 180 μm. FIG. 30 is a table showing the relationship between the electrode width (Line) between the fine slits 36 and the width (Space) of the fine slit 36 and a mode efficiency in a case that the pixel pitch is 240 μm. Note that the mode efficiency of the present evaluation item is the value when the mode efficiency in a case that Line/Space=2.1 μm/3.1 μm is normalized as 1.

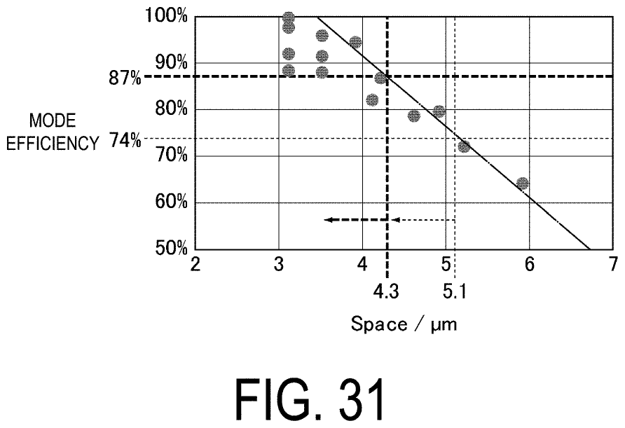

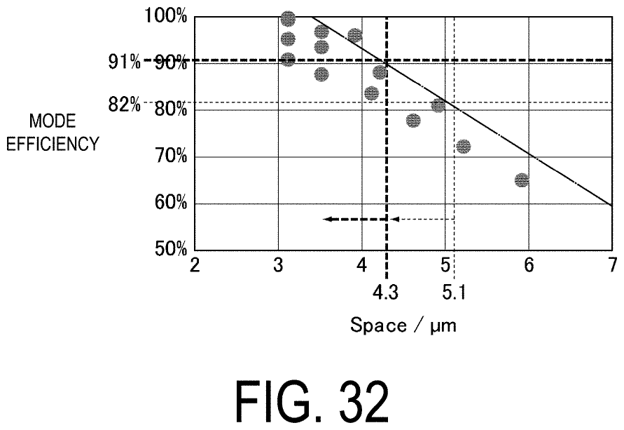

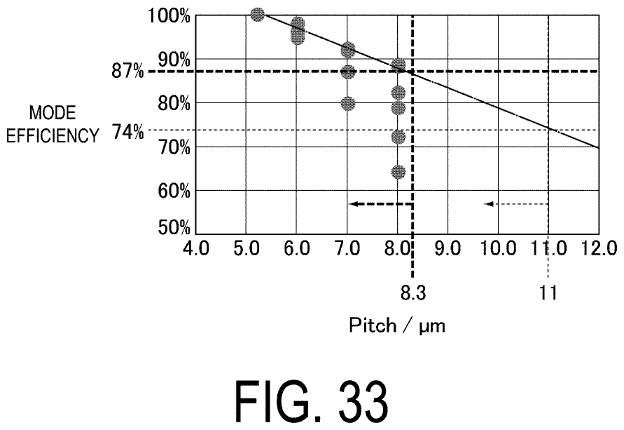

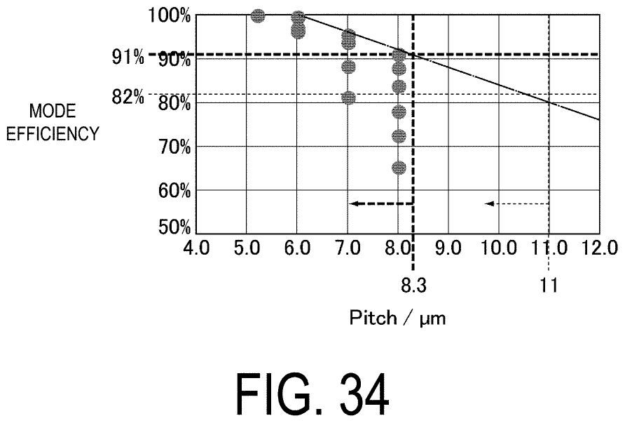

The graphs of FIGS. 31 to 34 were created on the basis of the results shown in FIGS. 29 and 30. FIG. 31 is a graph showing a relationship between the width (Space) of the fine slit 36 and the mode efficiency in the case that the pixel pitch is 180 μm. FIG. 32 is a graph showing the relationship between the width (Space) of the fine slit 36 and the mode efficiency in the case that the pixel pitch is 240 μm. FIG. 33 is a graph showing a relationship between a pitch (Line+Space) of the fine slit 36 and the mode efficiency in the case that the pixel pitch is 180 μm. FIG. 34 is a graph showing a relationship between the pitch (Line+Space) of the fine slit 36 and the mode efficiency in the case that the pixel pitch is 240 μm.

In the graphs of FIGS. 31 to 34, a straight line is drawn through a measuring point on the rightmost side (large side) in an X axis (width or pitch of the fine slit 36) direction, and the width (Space) of the fine slit 36 and the pitch (Line+Space) of the fine slit 36 at which the same mode efficiency as a mode efficiency in a case that the fine slit 36 is not provided (pixel pitch of 180 μm: 74%, pixel pitch of 240 μm: 82%) can be obtained were each determined. Further, the width (Space) of the fine slit 36 and the pitch (Line+Space) of the fine slit 36 were each determined at which a mode efficiency is reduced from the mode efficiency in the case that Line/Space=2.1 μm/3.1 μm by half of the difference between the mode efficiency in the case that Line/Space=2.1 μm/3.1 μm and the mode efficiency in the case that the fine slit 36 is not provided (pixel pitch of 180 μm: 87%, pixel pitch of 240 μm: 91%).

As a result, the electrode width (Line) between the fine slits 36 and the width (Space) of the fine slit 36 exhibited the same tendency in a case that the pixel pitch was 180 μm and in a case that the pixel pitch was 240 μm. That is, to obtain a mode efficiency greater than that without the fine slit 36, the width (Space) of the fine slit 36 and the pitch (Line+Space) of the fine slit 36 preferably satisfy the conditions below.

Width (Space) of fine slit 36 ≤5.1 μm

Pitch (Line+Space) of fine slit 36 ≤11 μm

Further, to ensure that a mode efficiency is reduced from the mode efficiency in the case that Line/Space=2.1 μm/3.1 μm by half of the difference between the mode efficiency in the case that Line/Space=2.1 μm/3.1 μm and the mode efficiency in the case that the fine slit is not provided, the width (Space) of the fine slit 36 and the pitch (Line+Space) of the fine slit 36 more preferably satisfy the conditions below.

Width (Space) of fine slit 36 <4.3 μm

Pitch (Line+Space) of fine slit 36 <8.3 μm

Next, a method for manufacturing the liquid crystal display panel 100 of the present embodiment will be described below. The method for manufacturing the liquid crystal display panel 100 of the present embodiment is not particularly limited to a specific method, but a method usually used in the field of liquid crystal display panels can be adopted. For example, the alignment process with respect to the first photo-alignment film 71 and the second photo-alignment film 72 is performed by a photo-alignment process in which light (electromagnetic waves) such as ultraviolet light and visible light is emitted. The photo-alignment process may be performed by using, for example, a device that includes a light source configured to irradiate the first photo-alignment film 71 and the second photo-alignment film 72 with light and has a function capable of continuously performing scanning exposure over a plurality of pixels. Examples of specific aspects of the scanning exposure include the aspect of irradiating the surface of the substrate with a light beam emitted from the light source while moving the substrate, the aspect of irradiating the surface of the substrate with a light beam emitted from the light source while moving the light source, and the aspect of irradiating the surface of the substrate with a light beam emitted from the light source while moving the light source and the substrate.

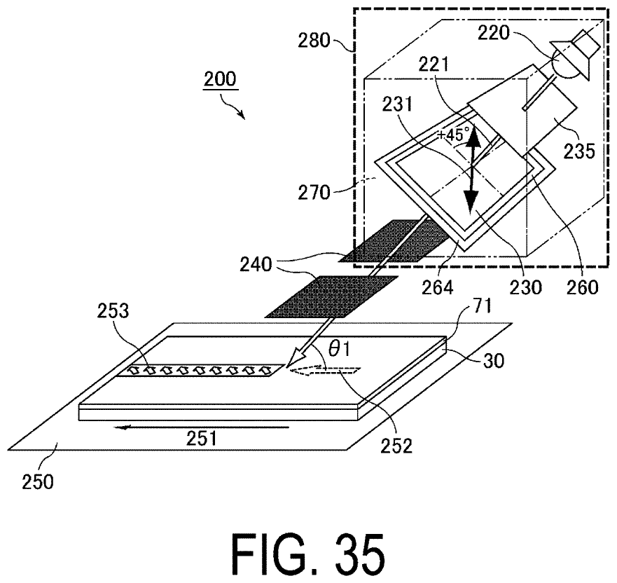

A specific example of the alignment process will be described below. FIG. 35 is a schematic view illustrating an example of a photo-alignment processing device. A photo-alignment processing device 200 illustrated in FIG. 35 performs the photo-alignment process on the photo-alignment film formed on the liquid crystal display panel substrate. The first photo-alignment film 71 formed on the first substrate (liquid crystal display panel substrate) 30 is illustrated in FIG. 35; however, the second photo-alignment film 72 can also be processed. The photo-alignment processing device 200 includes a photo-irradiation mechanism 280 and a stage 250 on which the liquid crystal display panel substrate 30 is mounted.

The photo-irradiation mechanism 280 includes a light source 220, a polarizer 230, and a rotation adjustment mechanism 260. The light source 220 and the polarizer 230 may be disposed in a lamp box 270. A type of the light source 220 is not particularly limited to a specific type, but a light source commonly used in the field of photo-alignment processing devices can be used. For example, a low-pressure mercury lamp, a deuterium lamp, a metal halide lamp, an argon resonance lamp, a xenon lamp, and the like can be used.

Light 221 emitted from the light source 220 may be light (electromagnetic wave) such as ultraviolet light and visible light, and the light 221 preferably has a wavelength from 280 nm to 400 nm.

For example, the polarizer 230 extracts linearly polarized light from the light emitted from the light source 220 toward the liquid crystal display panel substrate 30. Note that the term “polarization axis” refers to a direction in which the amount of light passing through the polarizer is maximum. Examples of the polarizer 230 include an organic resin polarizer, a wire grid polarizer, and a Polarizing beam splitter (PBS).

Examples of the organic resin polarizer include a polarizer obtained by causing polyvinyl alcohol to adsorb iodine and extending the resultant in a sheet shape, and the like.

For example, the wire grid polarizer includes an optical transparency base material and a plurality of metal thin wires formed on the optical transparency base material, and the plurality of metal thin wires are disposed in a period shorter than the wavelength of light incident on the wire grid polarizer. The metal thin wire is made of a light absorbing metal material such as chromium, for example. When the wire grid polarizer is irradiated with the light while overlapping with the liquid crystal display panel substrate 30, the liquid crystal molecules are aligned in the azimuthal direction orthogonal to an extending direction of the metal thin wire. In a case that the polarizer 230 is the wire grid polarizer, the polarization axis is the azimuthal direction orthogonal to the extending direction of the metal thin wire. Alignment division treatment can efficiently be performed using the wire grid polarizer having a different extending direction of the metal thin wire.

Examples of the polarizing beam splitter include a cube type and a plate type. Examples of the cube type PBS include a PBS in which inclined surfaces of two prisms are bonded together and an optical thin film is deposited on one of the inclined surfaces.

The polarizer 230 may be disposed perpendicular to an irradiation axis of the light. In a case that the polarizer 230 is not disposed perpendicular to the irradiation axis of the light, the alignment of the liquid crystal molecules may be influenced by a waveguide effect or the like in the polarizer 230. The irradiation axis of the light is a direction in which the light 221 emitted from the light source 220 toward the liquid crystal display panel substrate 30 propagates linearly. The polarizer being disposed perpendicular to the irradiation axis of the light means that the polarizer is disposed such that the light is emitted from the polarizer toward the liquid crystal display panel substrate in a normal direction of the polarizer, and the term “perpendicular” means a range in which an angle formed between the normal line of the polarizer and the irradiation axis of the light is less than 0.5°.

A wavelength selection filter 235 may be included between the light source 220 and the polarizer 230. A main wavelength of the light emitted through the wavelength selection filter 235 may be from 280 nm to 400 nm. Light having a selection wavelength from 280 nm to 400 nm can generate a structural change of a material constituting the first photo-alignment film 71 and exhibiting the photo-alignment characteristic, and cause the material to exert the alignment regulation force. An intensity of the light emitted from the light source may be from 10 mJ/cm² to 100 mJ/cm².

The wavelength selection filter 235 is not particularly limited to a specific filter, and a wavelength selection filter commonly used in the field of photo-alignment processing devices can be used. Examples of the wavelength selection filter 235 include a wavelength selection filter in which a substance absorbing light having a wavelength other than the transmission wavelength is dispersed in the filter, a wavelength selection filter in which the surface of the filter is coated with a substance reflecting light having a wavelength other than the transmission wavelength, or the like.

The irradiation angle of the light relative to the liquid crystal display panel substrate 30 may be from 30° to 60°. The irradiation angle is represented by θ1 in FIG. 35, and is an angle formed between a plane of the liquid crystal display panel substrate 30 and the irradiation axis of the light in a case that the surface of the liquid crystal display panel substrate 30 is set to 0°, and the normal line of the liquid crystal display panel substrate 30 is set to 90°.

An extinction ratio of the polarizer may be from 50:1 to 500:1. The extinction ratio is represented by Tmax:Tmin, where Tmax is maximum transmittance in a case that the polarizer is irradiated with the light and Tmin is minimum transmittance obtained by rotating the polarizer by 90°. The light in the more desired polarization axis direction can be taken out as the extinction ratio is great (a value of Tmax in a case that Tmin is set to 1), and thus a variation in the tilt azimuthal direction of the liquid crystal molecules can be reduced.

The rotation adjustment mechanism 260 rotates a polarization axis 231 of the polarizer 230, and adjusts an exposure direction 253 on the surface of the liquid crystal display panel substrate 30 such that the exposure direction 253 substantially becomes 45° relative to an irradiation direction 252 of the light. By setting the exposure direction 253 to substantially 45° relative to the irradiation direction 252 of the light, the photo-alignment process can be performed on the liquid crystal display panel substrate 30 by scanning exposure having excellent productivity while a movement direction 251 of the liquid crystal display panel substrate 30 is kept in parallel with the irradiation direction 252 of the light. As illustrated in FIG. 35, the irradiation direction 252 of the light means a light traveling direction in a case that the light 221 emitted from the light source 220 is projected onto the surface of the liquid crystal display panel substrate 30. The exposure direction 253 means a vibration direction of polarized light emitted from the light source 220 to the surface of the liquid crystal display panel substrate 30 through the polarizer 230. A pre-tilt azimuthal direction that the alignment film 70 formed on the surface of the liquid crystal display panel substrate 30 imparts to the liquid crystal molecules is determined by the exposure direction 253.

For example, the polarization axis 231 is adjusted using the rotation adjustment mechanism 260 by the following method. The polarizer 230 is set such that the polarization axis 231 becomes 45° relative to the irradiation direction 252 of the light. The azimuthal direction of the polarization axis before the polarization axis is adjusted by the rotation adjustment mechanism may be referred to as “a 45° azimuthal direction”. Next, the rotation adjustment mechanism 260 rotates the polarizer 230 from the 45° azimuthal direction to adjust the azimuthal direction of the polarization axis 231 on the basis of data calculated by geometric computation in consideration of the light irradiation angle relative to the liquid crystal display panel substrate and a refractive index of the alignment film material. The rotation adjustment mechanism 260 can match the azimuthal direction of the polarization axis of the polarizer relative to the irradiation direction of the light with the exposure direction on the surface of the liquid crystal display panel substrate to set the tilt azimuthal direction of the liquid crystal molecules in the liquid crystal display panel to a desired angle. Note that when the photo-alignment process is performed without the rotation adjustment mechanism 230 while the polarization axis 231 is fixed to the 45° azimuthal direction, the tilt azimuthal direction of the liquid crystal molecules deviates by about from 10° to 45°.

The rotation adjustment mechanism 260 may rotate the polarization axis of the polarizer 230 within a range from −15° to +15° from the 45° azimuthal direction. When the rotation adjustment mechanism rotates the polarization axis within the range from −15° to +15°, even in a case where the light irradiation angle is changed relative to the liquid crystal display panel substrate 30, the exposure direction 253 can be adjusted to set the tilt azimuthal direction of the liquid crystal molecules to the desired angle. For example, the polarization axis 231 is rotated from the 45° azimuthal direction by +7.55° and set to 52.55° in order to adjust the exposure direction 253 on the surface of the liquid crystal display panel substrate plane to substantially 45° relative to the irradiation direction 252 of the light.

The photo-alignment processing device 200 may further include a rotation mechanism 264. The rotation mechanism 264 can rotate the polarization axis 231 of the polarizer 230 by selecting either substantially 45° or substantially 90° from the 45° azimuthal direction. In a case that a +45° azimuthal direction clockwise relative to the irradiation direction 252 of the light is set to the +45° azimuthal direction, and the polarization axis 231 of the polarizer 230 is rotated by 90° from the +45° azimuthal direction, the polarization axis 231 after rotation becomes a −45° azimuthal direction relative to the irradiation direction of the light. The polarization axis 231 is rotated by 90° from the +45° azimuthal direction and further adjusted by the rotation adjustment mechanism 260, which allows the light irradiation to be performed while the exposure direction 253 is set to substantially 45° relative to the irradiation direction 252 of the light before and after the rotation. Consequently, the embodiment is suitable for manufacturing a liquid crystal display panel having a new alignment control mode, in which four alignment regions having mutually different tilt azimuthal directions of the liquid crystal molecules are disposed in the longitudinal direction of the pixel as illustrated in FIG. 2. Furthermore, the liquid crystal display panel having the new alignment control mode can be manufactured by the scanning exposure, and thus the production efficiency can be significantly improved. The term “substantially 45° or substantially 90° from the 45° azimuthal direction” means a range in which an angle of 15° clockwise or counterclockwise from 45° or 90° relative to the 45° azimuthal direction is formed, respectively. The 45° azimuthal direction and the 90° azimuthal direction refer to a range of ±0.5° from 45° and 90°, respectively.

The rotation mechanism 264 can also rotate the polarization axis 231 of the polarizer 230 from the 45° azimuthal direction by substantially 45°. When the polarization axis 231 is rotated by 45° from the 45° azimuthal direction, the polarization axis 231 after rotation is parallel with the irradiation direction of the light, and thus the conventional photo-alignment process in which the polarization axis of the polarizer and the irradiation direction of the light are caused to match can also be performed.

The stage 250 is a stage on which the liquid crystal display panel substrate 30 is mounted. The liquid crystal display panel substrate 30 is fixed onto the stage 250 and irradiated with the light while being moved, or the liquid crystal display panel substrate 30 is irradiated with the light while the light source is moved relative to the liquid crystal display panel substrate 30. The photo-alignment process can be efficiently performed by performing such a scanning exposure. The movement direction of the liquid crystal display panel substrate 30 or the movement direction of the light source 220 is parallel with the irradiation direction of the light relative to the liquid crystal display panel substrate 30, and thus an incident angle of light incident on the substrate from the light source becomes substantially the same in a light irradiation area of the light source, making a pre-tilt angle (polar angle) provided to the liquid crystal molecules also become substantially the same. For this reason, a variation in pre-tilt angle in the light irradiation area is suppressed to manufacture the liquid crystal display panel having excellent display quality. The photo-alignment processing device 200 may include a stage scanning mechanism that moves the stage 250 and/or a light source scanning mechanism that moves the light source 220. The term “parallel” includes a range in which the angle formed between the irradiation direction of the light and the movement direction of the liquid crystal display panel substrate 30 or the movement direction of the light source 220 is less than 5°.

In addition to the mechanisms described above, the photo-alignment processing device 200 may include a light blocking member 240. The alignment division treatment can be performed by performing the photo-alignment process while a portion not irradiated with the light is blocked by the light blocking member 240.

With use of the photo-alignment processing device, the azimuthal direction of the polarization axis of the polarizer relative to the irradiation direction of the light can be made to match the exposure direction on the surface of the liquid crystal display panel substrate and set the tilt azimuthal direction of the liquid crystal molecules 41 in the liquid crystal display panel 100 to the desired angle.

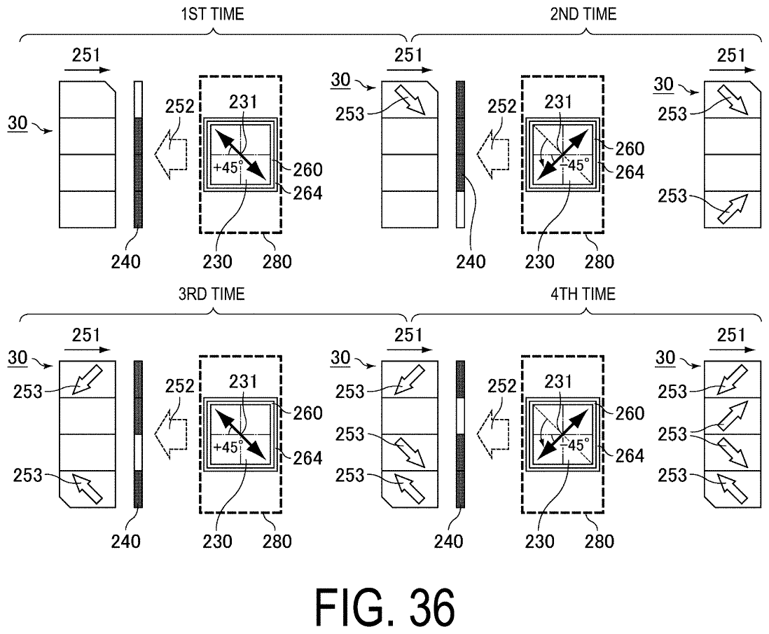

An example of a photo-alignment processing step using the photo-alignment processing device 200 will be described below with reference to FIG. 36. FIG. 36 is a diagram illustrating an example of the photo-alignment processing step using the photo-alignment processing device. The photo-alignment processing step illustrated in FIG. 36 is an example in which, using the photo-irradiation mechanism 280 including one polarizer 230, the polarization axis 231 of the polarizer 230 is rotated by the rotation mechanism 264 to perform the photo-alignment process. In FIG. 36, to describe the orientation of the liquid crystal display panel substrate 30, a cut-out portion is illustrated in one corner. However, the actual liquid crystal display panel substrate 30 need not include the cut-out portion.

As illustrated in FIG. 36, the movement direction 251 of the liquid crystal display panel substrate 30 is set to the first direction, the irradiation direction 252 of the light is set to the second direction, and the first-time light irradiation is performed through the wavelength selection filter 235 (not illustrated) and the polarizer 230 using the photo-irradiation mechanism 280. The first direction and the second direction are parallel with each other. The light is blocked by the light blocking member 240 at the region not irradiated with the light. After the polarization axis 231 of the polarizer 230 is set to the +45° azimuthal direction clockwise relative to the irradiation direction 252 of the light, and subsequently the rotation adjustment mechanism 260 adjusts the exposure direction 253 on the surface of the liquid crystal display panel substrate 30 to substantially 45° relative to the irradiation direction 252 of the light, the first-time light irradiation is performed. Subsequently, after the light blocking member 240 is moved, the polarization axis 231 of the polarizer 230 is rotated by 90° from the +45° azimuthal direction by the rotation mechanism 264 and set to the −45° azimuthal direction counterclockwise relative to the irradiation direction 252 of the light, the polarization axis 231 is adjusted by the rotation adjustment mechanism 260, and the second-time light irradiation is performed. Subsequently, the substrate is rotated by 180°, the light blocking member 240 is further moved, the polarizer 230 is rotated by 90° from the −45° azimuthal direction by the rotation mechanism 264 and set to the +45° azimuthal direction, the polarization axis 231 is adjusted by the rotation adjustment mechanism 260, and the third-time light irradiation is performed. Finally, the light blocking member 240 is moved, the polarizer 230 is rotated by 90° from the +45° azimuthal direction by the rotation mechanism 264 and set to the −45° azimuthal direction, and then the polarization axis 231 is adjusted by the rotation adjustment mechanism 260, and the fourth-time light irradiation is performed. In the liquid crystal display panel substrate 30 subjected to the light irradiation step, a pre-tilt azimuthal direction 253 varies in each of regions corresponding to the four alignment regions formed in one pixel. The movement direction 251 of the Tliquid crystal display panel substrate 30 and the irradiation direction 252 of the light are the same in all the first-time light irradiation to the fourth-time light irradiation. Further, in all the first-time light irradiation to the fourth-time light irradiation, the polarization axis 231 is adjusted by the rotation adjustment mechanism 260 such that the exposure direction 253 on the surface of the liquid crystal display panel substrate 30 becomes substantially 45° relative to the irradiation direction 252 of the light.

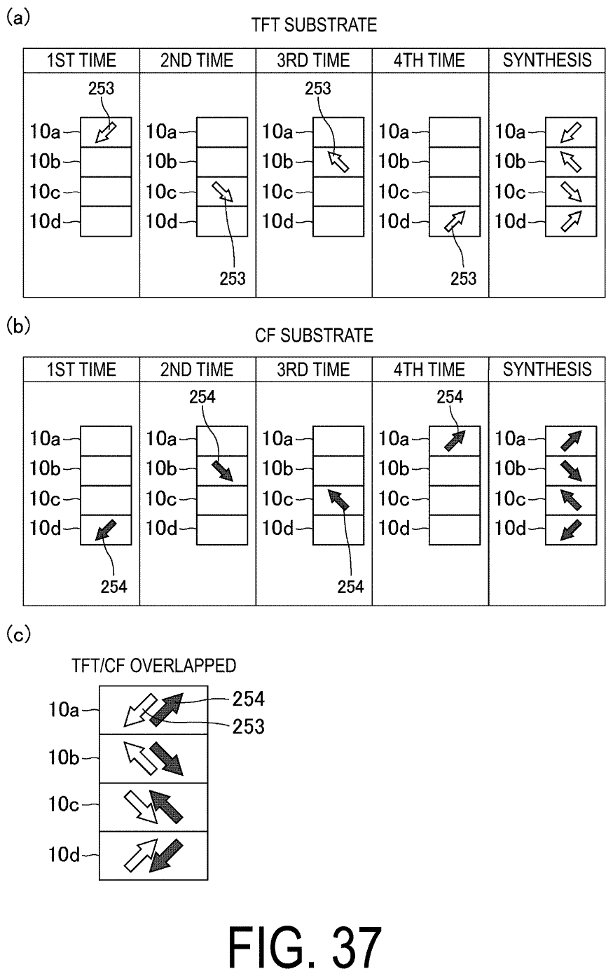

FIG. 37(a) is an explanatory view of a photo-alignment process of a TFT substrate (first substrate), FIG. 37(b) is an explanatory view of a photo-alignment process of a CF substrate (second substrate), and FIG. 37(c) is an explanatory view of a state after the TFT substrate and the CF substrate, which were subjected to the photo-alignment process, were bonded. As illustrated in FIG. 37(a), the TFT substrate (first substrate) 30 is subjected to the photo-alignment process while changing the pre-tilt azimuthal direction 253 in each domain for each of the first-time light irradiation to the fourth-time light irradiation. Further, in the same manner as in the TFT substrate, as illustrated in FIG. 37(b), the CF substrate (second substrate) 50 is also subjected to the photo-alignment process by changing a pre-tilt azimuthal direction 254 in each domain for each of the first-time light irradiation to the fourth-time light irradiation. As illustrated in FIGS. 37(a) and 37(b), the first domain 10a, the second domain 10b, the third domain 10c, and the fourth domain 10d included in the liquid crystal display panel 100 of the embodiment are completed when the TFT substrate 30 and the CF substrate 50 subjected to the photo-alignment process are bonded together.

### Supplement

An aspect of the present invention is a liquid crystal display panel including, in the following order, a first substrate including a plurality of pixel electrodes and a first photo-alignment film, a liquid crystal layer containing liquid crystal molecules, and a second substrate including a common electrode and a second photo-alignment film. Given an alignment vector in which a major axis edge of the liquid crystal molecules closer to the first substrate is set to a start point and a major axis edge of the liquid crystal molecules closer to the second substrate is set to an end point, the first photo-alignment film and the second photo-alignment film are subjected to an alignment process such that a plurality of domains are formed in a display unit region overlapping with one of the plurality of pixel electrodes, with the alignment vectors of the plurality of domains differing from one another. The plurality of domains include a first domain, a second domain, a third domain, and a fourth domain disposed in order in a longitudinal direction of the display unit region. In a plan view of the plurality of domains, the alignment vector of the first domain and the alignment vector of the second domain have a mutually orthogonal relationship with the end points facing each other, the alignment vector of the second domain and the alignment vector of the third domain have a mutually parallel relationship with the start points facing each other, and the alignment vector of the third domain and the alignment vector of the fourth domain have a mutually orthogonal relationship with the end points facing each other.

The liquid crystal molecules may be aligned substantially perpendicular to the first substrate and the second substrate in a case that no voltage is applied to the liquid crystal layer, and aligned tilted to match each of the alignment vectors of the plurality of domains in a case that voltage is applied to the liquid crystal layer.

In each of the plurality of domains, an inter-substrate twist angle of the liquid crystal molecules may be 45° or less.

Each of the plurality of pixel electrodes may include, in a boundary region between the second domain and the third domain, a slit disposed along the boundary region and a connecting portion connecting a region overlapping with the second domain and a region overlapping with the third domain.

The slit may include a portion parallel with or perpendicular to an end of a pixel electrode of the plurality of pixel electrodes or a portion parallel with or perpendicular to a source wiring line, a gate wiring line, or an auxiliary capacitance wiring line. The slit may include a branch portion forming an angle of substantially 45° relative to a long side portion of the slit and extending directly from the long side portion of the slit. The slit may include a wide portion in at least one location. The slit may include a plurality of regions with differing positions of upper sides and/or lower sides. Each of the plurality of pixel electrodes may further include a plurality of the slits with differing upper sides and/or lower sides. A width of the slit may be from 1 to 8 μm.

Each of the plurality of pixel electrodes may include, at least on an edge of each of the plurality of pixel electrodes, a plurality of fine slits parallel with the alignment vector. The plurality of first fine slits may each have a width of 5.1 μm or less. The plurality of first fine slits may each have a width of 4.3 μm or less. The plurality of first fine slits may be disposed periodically every 11 μm or less. The plurality of first fine slits may be disposed periodically every 8.3 μm or less.

Each of the plurality of pixel electrodes may include a solid electrode portion sandwiched between disposed regions of the plurality of fine slits, in at least one of a boundary region between the first domain and the second domain or a boundary region between the third domain and the fourth domain.

Each of the plurality of pixel electrodes may have a structure having an arrangement density of electrodes that increases from an edge to a center in at least one of a region overlapping with the first domain, a region overlapping with the second domain, a region overlapping with the third domain, or a region overlapping with the fourth domain.

In each of the plurality of pixel electrodes, the plurality of fine slits may be provided in a region overlapping with the first domain, the second domain, the third domain, and the fourth domain.

The liquid crystal display panel may have a pixel density of 90 ppi or greater.

According to another aspect of the present invention, a method for manufacturing the liquid crystal display panel includes carrying out the alignment process on the first photo-alignment film and the second photo-alignment film, the alignment process including emitting polarized light from a light source through a polarizer from an oblique direction, rotating a polarization axis of the polarizer within a range from −15° to +15° from a 45° azimuthal direction, and adjusting an exposure direction on surfaces of the first photo-alignment film and the second photo-alignment film to a substantially 45° azimuthal direction relative to an irradiation direction of light.

According to yet another aspect of the present invention, a photo-alignment processing device used in the method for manufacturing a liquid crystal display panel includes at least one photo-irradiation mechanism including a light source, a polarizer, and a rotation adjustment mechanism, and configured to emit light from the light source to a liquid crystal display panel substrate through the polarizer, and a stage on which the liquid crystal display panel substrate is mounted. Light is emitted while the liquid crystal display panel substrate is moved or while the light source is moved relative to the liquid crystal display panel substrate, an irradiation direction of the light relative to the liquid crystal display panel substrate and a movement direction of the liquid crystal display panel substrate or a movement direction of the light source are parallel, and the rotation adjustment mechanism is configured to rotate the polarization axis of the polarizer and adjust the exposure direction on a substrate plane of the liquid crystal display panel to a substantially 45° azimuthal direction relative to the irradiation direction of the light.

### REFERENCE SIGNS LIST

10, 11 Pixel
10a First domain
10b Second domain
10c Third domain
10d Fourth domain
13 TFT
20 Back face side polarizer
30 First substrate (liquid crystal display panel substrate)
31 Pixel electrode
33 Slit (center slit)
34 Connecting portion
36 Fine slit
37 Electrode connecting portion
38 Wide portion
39 Branch portion
40 Liquid crystal layer
41 Liquid crystal molecule
41S Start point (tail of liquid crystal director)
41T End point (head of liquid crystal director)
50 Second substrate
51 Counter electrode
60 Display surface side polarizer
71 First photo-alignment film
72 Second photo-alignment film
80 Sealing member
100, 300, 400 Liquid crystal display panel
110 Backlight
200 Photo-alignment processing device
220 Light source
221 Light
230 Polarizer
231 Polarization axis
235 Wavelength selection filter
240 Light blocking member
250 Stage
251 Substrate movement direction
252 Irradiation direction of light
253, 254 Exposure direction (pre-tilt direction)
260 Rotation adjustment mechanism
264 Rotation mechanism
270 Lamp box
280 Photo-irradiation mechanism
D Drain
G1, G2 Gate signal line
S1, S2, S3, S4 Source signal line

1. A liquid crystal display panel comprising, in the following order:
a first substrate including a plurality of pixel electrodes and a first photo-alignment film;
a liquid crystal layer containing liquid crystal molecules; and
a second substrate including a common electrode and a second photo-alignment film,
wherein, given an alignment vector in which a major axis edge of the liquid crystal molecules closer to the first substrate is set to a start point and a major axis edge of the liquid crystal molecules closer to the second substrate is set to an end point, the first photo-alignment film and the second photo-alignment film are subjected to an alignment process such that a plurality of domains are formed in a display unit region overlapping with one of the plurality of pixel electrodes, with the alignment vectors of the plurality of domains differing from one another,
the plurality of domains include a first domain, a second domain, a third domain, and a fourth domain disposed in order in a longitudinal direction of the display unit region, and
in a plan view of the plurality of domains,
the alignment vector of the first domain and the alignment vector of the second domain have a mutually orthogonal relationship with the end points facing each other,
the alignment vector of the second domain and the alignment vector of the third domain have a mutually parallel relationship with the start points facing each other, and
the alignment vector of the third domain and the alignment vector of the fourth domain have a mutually orthogonal relationship with the end points facing each other.

2. The liquid crystal display panel according to claim 1,
wherein the liquid crystal molecules are aligned substantially perpendicular to the first substrate and the second substrate in a case that no voltage is applied to the liquid crystal layer, and aligned tilted to match each of the alignment vectors of the plurality of domains in a case that voltage is applied to the liquid crystal layer.

3. The liquid crystal display panel according to claim 1,
wherein, in each of the plurality of domains, an inter-substrate twist angle of the liquid crystal molecules is 45° or less.

4. The liquid crystal display panel according to claim 1,
wherein each of the plurality of pixel electrodes include, in a boundary region between the second domain and the third domain,
a slit disposed along the boundary region and
a connecting portion connecting a region overlapping with the second domain and a region overlapping with the third domain.

5. The liquid crystal display panel according to claim 4,
wherein the slit includes
a portion parallel with or perpendicular to an end of a pixel electrode of the plurality of pixel electrodes or
a portion parallel with or perpendicular to a source wiring line, a gate wiring line, or capacitance wiring line.

6. The liquid crystal display panel according to claim 4,
wherein the slit includes a branch portion forming an angle of substantially 45° relative to a long side portion of the slit and extending directly from the long side portion of the slit.

7. The liquid crystal display panel according to claim 4,
wherein the slit includes a wide portion in at least one location.

8. The liquid crystal display panel according to claim 4,
wherein the slit includes a plurality of regions with differing positions of upper sides and/or lower sides.

9. The liquid crystal display panel according to claim 4,
wherein each of the plurality of pixel electrodes further includes a plurality of the slits with differing upper sides and/or lower sides.

10. The liquid crystal display panel according to claim 4,
wherein a width of the slit is from 1 to 8 μm.

11. The liquid crystal display panel according to claim 1,
wherein each of the plurality of pixel electrodes includes, at least on an edge of each of the plurality of pixel electrodes, a plurality of fine slits parallel with the alignment vector.

12. The liquid crystal display panel according to claim 11,
wherein the plurality of fine slits each have a width of 5.1 μm or less.

13. The liquid crystal display panel according to claim 11, wherein the plurality of fine slits each have a width of 4.3 μm or less.

14. The liquid crystal display panel according to cliaim 11,
wherein the plurality of fine slits are disposed periodically every 11 μm or less.

15. The liquid crystal display panel according to claim 11,
wherein the plurality of fine slits are disposed periodically every 8.3 μm or less.

16. The liquid crystal display panel according to claim 11,
wherein each of the plurality of pixel electrodes includes a solid electrode portion sandwiched between disposed regions of the plurality of fine slits, in at least one of a boundary region between the first domain and the second domain or a boundary region between the third domain and the fourth domain.

17. The liquid crystal display panel according to claim 11,
wherein each of the plurality of pixel electrodes has a structure having an arrangement density of electrodes that increases from an edge to a center in at least one of a region overlapping with the first domain, a region overlapping with the second domain, a region overlapping with the third domain, or a region overlapping with the fourth domain.

18. The liquid crystal display panel according to claim 11,
wherein, in each of the plurality of pixel electrodes, the plurality of fine slits are provided in a region overlapping with the first domain, the second domain, the third domain, and the fourth domain.

19. The liquid crystal display panel according to claim 1,
wherein a pixel density is 90 pixel per inch or greater.

20. A method for manufacturing the liquid crystal display panel described in claim 1, comprising:
carrying out the alignment process on the first photo-alignment film and the second photo-alignment film, the alignment process including emitting polarized light from a light source through a polarizer from an oblique direction;
rotating a polarization axis of the polarizer within a range from −15° to +15° from a 45° azimuthal direction; and
adjusting an exposure direction on surfaces of the first photo-alignment film and the second photo-alignment film to a substantially 45° azimuthal direction relative to an irradiation direction of light.

21. A photo-alignment processing device used in the method for manufacturing a liquid crystal display panel described in claim 20, comprising:
at least one photo-irradiation mechanism including a light source, a polarizer, and a rotation adjustment mechanism, and configured to emit light from the light source to a liquid crystal display panel substrate through the polarizer; and
a stage on which the liquid crystal display panel substrate is mounted,
wherein light is emitted while the liquid crystal display panel substrate is moved or while the light source is moved relative to the liquid crystal display panel substrate,
an irradiation direction of the light relative to the liquid crystal display panel substrate and a movement direction of the liquid crystal display panel substrate or a movement direction of the light source are parallel, and
the rotation adjustment mechanism is configured to rotate the polarization axis of the polarizer and adjust the exposure direction on a substrate plane of the liquid crystal display panel to a substantially 45° azimuthal direction relative to the irradiation direction of the light.
